(19) United States
(12) Patent Application Publication
(10) Pub. No.: US 2026/0287250 A1
(43) Pub. Date: Sep. 24, 2026

(54) HOME APPLIANCE INCLUDING CAMERA, AND OPERATING METHOD THEREOF

(71) Applicant: Samsung Electronics Co., Ltd., Suwon-si (KR)

(72) Inventors: Jayoung YANG, Suwon-si (KR); Minjin SONG, Suwon-si (KR); Juhee JEONG, Suwon-si (KR); Hojun BAEK, Suwon-si (KR)

(21) Appl. No.: 19/685,559

(22) Filed: May 22, 2026

Related U.S. Application Data
(63) Continuation of application No. PCT/KR2024/017531, filed on Nov. 7, 2024.

(30) Foreign Application Priority Data
Nov. 23, 2023 (KR) 10-2023-0164842

(51) Int. Cl. F25D 29/00; F25D 23/02

(52) U.S. Cl. CPC F25D 29/00; F25D 23/028; F25D 2700/02; F25D 2700/04; F25D 2700/06

(57) ABSTRACT

A home appliance are provided. The home appliance includes a camera, a memory, comprising one or more storage media, storing instructions, and at least one processor communicatively coupled to the camera and the memory, wherein the instructions, when executed by the at least one processor individually or collectively, cause the home appliance to based on a user trigger, control the camera to be turned on, control the camera to perform first correction of at least one setting value based on a surrounding light environment around the home appliance, obtain at least one first corrected setting value based on the first correction, and based on a door opening event of the home appliance and based on the at least one first corrected setting value, obtain an image captured through the camera.

### CROSS-REFERENCE TO RELATED APPLICATION(S)

This application is a continuation application, claiming priority under 35 U.S.C. § 365(c), of an International application No. PCT/KR 2024/017531, filed on Nov. 7, 2024, which is based on and claims the benefit of a Korean patent application number 10-2023-0164842, filed on Nov. 23, 2023, in the Ministry of Intellectual Property (MOIP), the disclosure of which is incorporated by reference herein in its entirety.

### BACKGROUND

### 1. Field

The disclosure relates to a home appliance including a camera and an operating method of the home appliance.

### 2. Description of Related Art

Recently, components such as cameras have been added to home appliances, making it possible to monitor objects entering and exiting the home appliances. For example, information about food entering a refrigerator is checked or a cooking process in an oven is monitored by using an image captured using a camera function.

Object recognition processing may be applied, by using an artificial intelligence model, to images captured by a home appliance. However, when the brightness of the captured image is not clear, or a color tone is inconsistent, it may be difficult to accurately recognize objects. Accordingly, a camera included in the home appliance may perform operations of adjusting the brightness of the captured image clearly or adjusting the color tone to be consistent. When performing object recognition with corrected captured images, the accuracy of object recognition may be improved.

However, as a time required for the camera to capture an image of objects entering or exiting the home appliance and to adjust the brightness or color tone of the captured image increases, it becomes more difficult for a user to monitor the objects entering or exiting the home appliance in real time, and thus user convenience may be reduced.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a home appliance including a camera and an operating method of the home appliance.

Additional aspects will be set forth in part in the description which follows and, in part, will be apparent from the description, or may be learned by practice of the presented embodiments.

In accordance with an aspect of the disclosure, a home appliance is provided. The home appliance includes a camera, memory, including one or more storage media, storing instructions, and at least one processor communicatively coupled to the camera and the memory, wherein the instructions, when executed by at least one processor individually or collectively, cause the home appliance to based on a user trigger, control the camera to be powered on. The instructions, when executed by at least one processor individually or collectively, cause the home appliance to control the camera to perform first correction of at least one setting value based on a surrounding light environment around the home appliance. The instructions, when executed by at least one processor individually or collectively, cause the home appliance to obtain at least one first corrected setting value based on the first correction. The instructions, when executed by at least one processor individually or collectively, cause the home appliance to based on a door opening event of the home appliance and based on the at least one first corrected setting value, obtain an image captured through the camera.

In accordance with another aspect of the disclosure, a method performed by a home appliance including a camera is provided. The method includes based on a user trigger, controlling the camera to be powered on, controlling the camera to performe first correction of at least one setting value based on a surrounding light environment around the home appliance, obtain at least one first corrected setting value based on the first correction, and based on a door opening event of the home appliance and based on the at least one first corrected setting value, obtaining an image captured through the camera.

In accordance with another aspect of the disclosure, one or more non-transitory computer-readable storage media storing one or more computer programs including computer-executable instructions that, when executed by one or more processors of a home appliance device individually or collectively, cause the home appliance device to perform operations. The operations including based on a user trigger, controlling a camera to be powered on, controlling the camera to performe first correction of at least one setting value based on a surrounding light environment around the home appliance, obtain at least one first corrected setting value based on the first correction, and based on a door opening event of the home appliance and based on the at least one first corrected setting value, obtaining an image captured through the camera.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram for explaining an overview of an object recognition operation of a home appliance according to an embodiment of the disclosure;

FIG. 2A is a diagram for explaining an overview of an object recognition operation of a home appliance according to an embodiment of the disclosure;

FIG. 2B is a diagram for explaining an overview of an object recognition operation of a home appliance according to an embodiment of the disclosure;

FIG. 2C is a diagram for explaining an overview of an object recognition operation of a home appliance according to an embodiment of the disclosure;

FIG. 2D is a diagram for explaining an overview of an object recognition operation of a home appliance according to an embodiment of the disclosure;

FIG. 3 illustrates examples of a captured image corrected through a camera according to an embodiment of the disclosure;

FIG. 4 is a block diagram of a home appliance according to an embodiment of the disclosure;

FIG. 5A is a flowchart for explaining an operation in which a home appliance obtains a captured image through a camera, according to an embodiment of the disclosure;

FIG. 5B is a flowchart for explaining an operation in which a home appliance obtains a captured image through a camera, according to an embodiment of the disclosure;

FIG. 5C is a flowchart for explaining an operation in which a home appliance obtains a captured image through a camera, according to an embodiment of the disclosure;

FIG. 6 is a diagram showing a structure in which a home appliance includes a sensor, according to an embodiment of the disclosure;

FIG. 7 is a flowchart for explaining an operation in which a home appliance obtains a user trigger through a sensor, according to an embodiment of the disclosure;

FIG. 8 is a flowchart for explaining an operation in which a home appliance obtains a user trigger through a sensor, according to an embodiment of the disclosure;

FIG. 9 is a diagram showing external devices registered on a server under the same account as a home appliance, according to an embodiment of the disclosure;

FIG. 10 is a flowchart for explaining an operation in which a home appliance obtains a user trigger through a human body detection event in a house, according to an embodiment of the disclosure;

FIG. 11 is a flowchart for determining whether to enter a power saving mode based on a usage pattern of a home appliance, according to an embodiment of the disclosure;

FIG. 12 is a flowchart for explaining an operation for performing auto correction on a captured image based on changes in a surrounding light environment of a home appliance, according to an embodiment of the disclosure;

FIG. 13 is a graph showing exposure values obtained through auto exposure (AE) of a camera, according to an embodiment of the disclosure;

FIG. 14 is a flowchart for explaining an operation of obtaining a surrounding light environment change event around a home appliance, according to an embodiment of the disclosure;

FIG. 15 is an example diagram showing a surrounding light environment around a home appliance, according to an embodiment of the disclosure;

FIG. 16 is a flowchart for explaining an operation of obtaining a surrounding light environment change event around a home appliance, according to an embodiment of the disclosure;

FIG. 17 is a diagram illustrating an operation in which a home appliance obtains an adjustment value by using an inference model, according to an embodiment of the disclosure; and

FIG. 18 is a detailed block diagram of a home appliance according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure, the expression “at least one of a, b or c” may refer to “a”, “b”, “c”, “a and b”, “a and c”, “b and c”, “all of a, b and c”, or variations thereof.

In the disclosure, the term “and/or” includes any combination of a plurality of related described components or any one of the plurality of related described components. The terms such as “1st”, “2nd”, or “first” or “second” may be used merely to distinguish one component from another, and do not limit the components in any other aspect (e.g., importance or order).

Throughout the disclosure, unless explicitly described to the contrary, the word “comprise” or “include” and variations such as “comprises” or “includes” or “comprising” or “including”, will be understood to imply the inclusion of stated elements but not the exclusion of any other elements.

The terms such as “unit” or “module” disclosed in the disclosure mean units for processing at least one function or operation, which may be implemented by hardware or software such as field programmable gate array (FPGA) or application specific integrated circuit (ASIC), or in a combination of hardware and software. The term “unit” used in an embodiment of the disclosure is not limited to software or hardware. The “unit” used in the disclosure may be formed so as to be stored in an addressable storage medium, or may be formed so as to operate one or more processors. In an embodiment of the disclosure, the term “unit” may refer to components such as software components, object-oriented software components, class components, and task components, processes, functions, properties, procedures, subroutines, segments of program code, drivers, firmware, micro code, circuits, data, databases, data structures, tables, arrays, and parameters. Functions provided by certain elements and a certain “unit” may be combined in a smaller number of elements or may be separated into additional elements. In an embodiment, the “unit” may include one or more processors.

In an embodiment of the disclosure, combinations of each block of flowcharts and the flowcharts may be performed by computer program instructions. Computer program instructions may be installed on a processor of a general computer, a special computer or other programmable data processing equipment. The instructions executed through the processor of the computer or other programmable data processing equipment may generate an element for performing functions described in block(s) of flowcharts. Computer program instructions may be stored in computer available or computer readable memory that may aim for a computer or other data processing equipment to implement functions in a certain way. Instructions stored in the computer available or computer readable memory may also produce manufacturing items that contain instruction elements for performing the functions described in the block(s) of the flowcharts. It is also possible that computer program instructions are installed on a computer or other programmable data processing equipment.

Each block of flowcharts may indicate a part of a module, segment or code including one or more executable instruments for executing a certain logical function(s). In an embodiment of the disclosure, it is also possible that functions mentioned in the blocks are performed out of order. For example, two blocks that are consecutively shown may actually be performed at the same time, or in reverse order depending on the function.

Hereinafter, embodiments of the disclosure are described in detail such that those of skill in the art may easily implement the same with reference to the accompanying drawings. However, an embodiment of the disclosure may be implemented in various different forms and is not limited to the embodiments described herein. To clearly explain an embodiment of the disclosure in the drawings, portions that are not related to explanation are omitted, and similar portions are given similar drawing reference numerals throughout the specification.

In the specification, the ‘image’ may correspond to a still image, a video including a plurality of consecutive still images (or frames), or a video.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

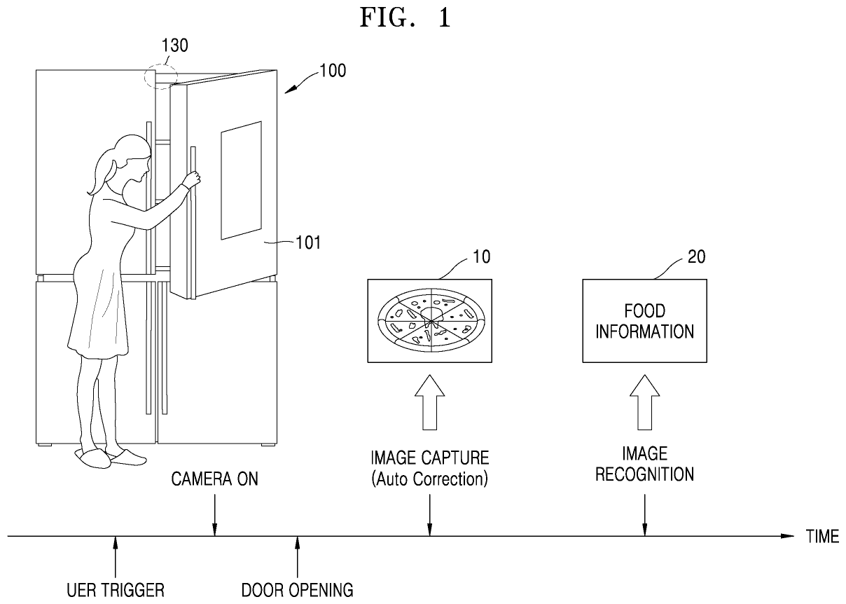

FIG. 1 is a diagram for explaining an overview of an object recognition operation of a home appliance according to an embodiment of the disclosure.

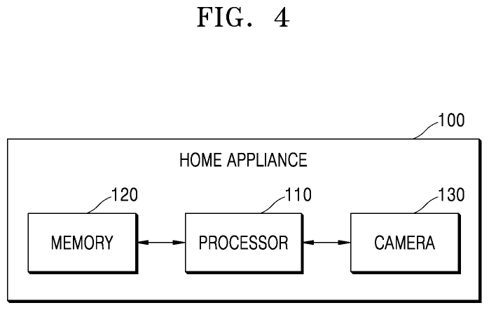

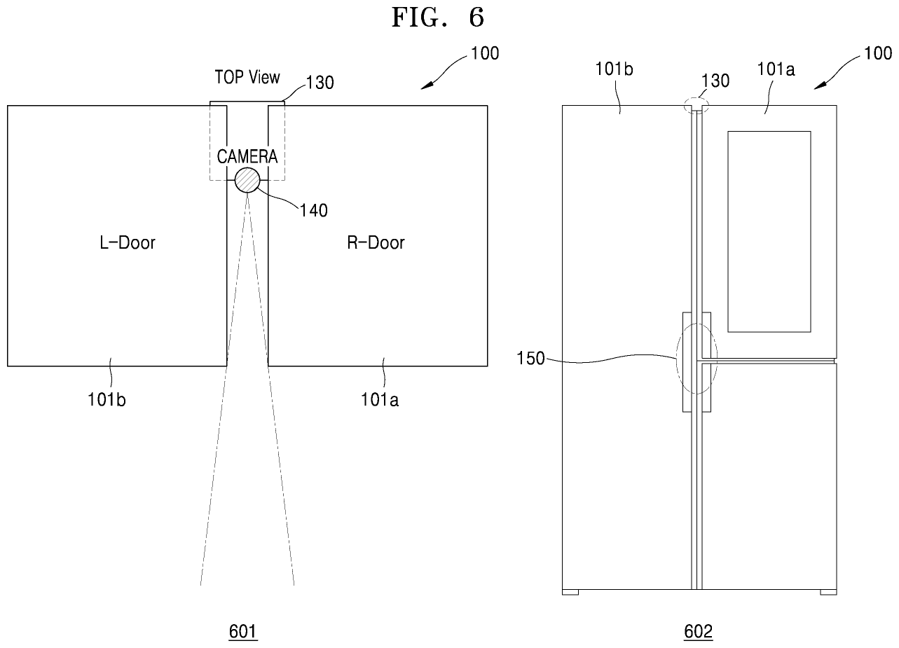

Referring to FIG. 1, a home appliance 100 according to an embodiment of the disclosure may include a camera 130 configured to photograph an object that enters or exits the home appliance 100. The home appliance 100 may further include at least one processor and memory 120 as illustrated in FIG. 4, which will be described below. The home appliance 100 may further include at least one sensor 140 and 150 illustrated in FIG. 6, which will be described below. In the disclosure, the home appliance 100 is exemplified as a refrigerator, but is not limited thereto. For example, the home appliance 100 may include various home appliances including a camera.

The camera 130 illustrated in FIG. 1 is installed to obtain an image of an inside or outside of the home appliance 100. For example, the camera 130 may be installed on one side of an upper portion of the home appliance 100. For example, the camera 130 may be installed inside a storage room of the home appliance 100. For example, the camera 130 may be installed between doors 101 of the home appliance.

The camera 130 illustrated in FIG. 1 may capture the image of the inside or outside of the home appliance 100 as still images or/and video. The camera 130 may be a wide-angle camera, a micro camera, or a pinhole camera, but is not limited thereto.

The home appliance 100 according to an embodiment of the disclosure may capture the image of the inside or outside of the home appliance 100 through the camera 130. For example, the camera 130 may perform image capture when the door 101 of the home appliance 100 is opened. The home appliance 100 may perform image recognition by using a captured image 10 obtained through the camera 130. The home appliance 100 may obtain at least one object information, such as food information 20, present in the captured image by performing image recognition.

The camera 130 according to an embodiment of the disclosure may have an auto correction function. For example, the auto correction function may include at least one of an auto exposure (AE) function, an auto white balance (AWB) function, and an auto focus (AF) function. The camera 130 may perform at least one of AE, AWB, and AF, and thus a user may easily obtain a high-quality image without any separate operation. It may be described that the AE operation, AWB operation, and AF operation of the camera 130 are each performed by an image signal processor (ISP) included in the camera 130. Here, the target of the auto correction may be at least one camera parameter including at least one of exposure value, white balance value, or focus value.

For example, the camera 130 may perform the AE operation. For example, the camera 130 may perform the AE operation when the door 101 of the home appliance 100 is opened.

The AE of the camera 130 is a function for obtaining a high-quality image by maintaining an appropriate exposure value according to changes in light entering through a lens included in the camera 130. For example, the AE of the camera 130 is a function that maintains a constant brightness of light received by an image sensor included in the camera 130 by automatically adjusting an exposure time by adjusting a shutter speed, or the like even when the ambient light of the camera 130 changes.

For example, the camera 130 may perform the AWB operation. For example, the camera 130 may perform the AWB operation when the door 101 of the home appliance 100 is opened.

The AWB of the camera 130 is a function that corrects a color tone of a white object such that the object appears white by adjusting color balance by correcting color of reflected light during image capture of the camera. During image capture of the camera, there is a difference in color representation depending on light. When a color temperature is low, the captured image appears red, and when the color temperature is high, the captured image appears blue. For example, under incandescent light, a subject appears red, under fluorescent light, the subject appears green, and under sunlight, the color temperature may vary depending on a time zone. As such, the camera 130 may perform white balance correction to correct for changes in color tone according to a light source. For example, the camera 130 may maintain an appropriate white balance value by determining the current color temperature according to white balance correction and correcting each component of the R, G, and B signals of the captured image based on the determined color temperature.

For example, the camera 130 may perform the AF operation. The AF of the camera 130 is a function that adjusts the focus such that the focus is automatically adjusted to the subject during image capture of the camera. Hereinafter, the AE operation and the AWB operation are described as an example of the auto correction operation performed by the camera 130, but the description may also be applied equally to the AF operations.

The home appliance 100 according to an embodiment of the disclosure may apply power to the camera 130 upon obtaining a user trigger. The camera 130 may be powered on in advance before a door opening event of the home appliance 100 occurs. The home appliance 100 may transmit an image capture request signal to the camera 130 when the door opening event occurs. The camera 130 may be in a powered-on standby state based on a user trigger and may perform image capture when the door opening event of the home appliance 100 occurs. The camera 130 may obtain a captured image with appropriately corrected brightness, color tone, color temperature, and the like by performing the AE operation and the AWB operation. The home appliance 100 may obtain information on at least one object present in a captured image by applying a captured image, in which brightness, color tone, color temperature, and the like are appropriately corrected, to an image recognition model.

In an embodiment of the disclosure, the home appliance 100 may reduce a time required to obtain a captured image by controlling the camera 130 to be powered on in advance before a door opening event occurs.

Hereinafter, with reference to other drawings, an operation in which the home appliance 100 according to an embodiment of the disclosure obtains a user trigger for applying power to the camera 130 before a door opening event occurs is described.

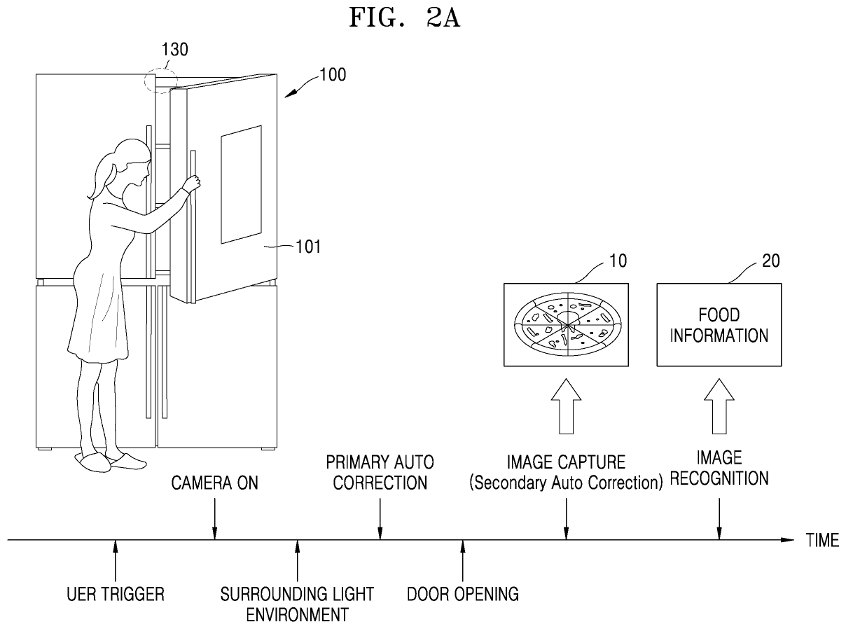

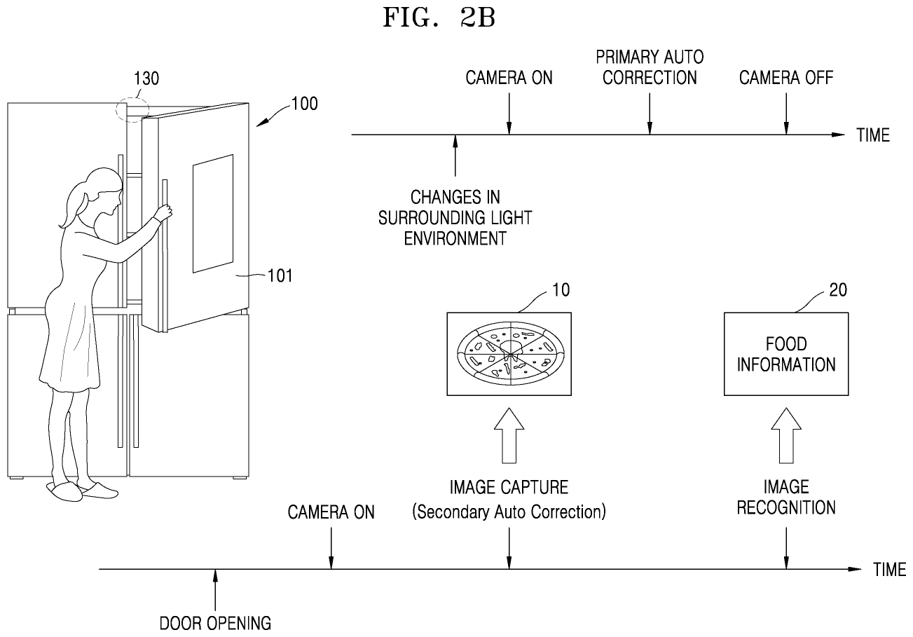

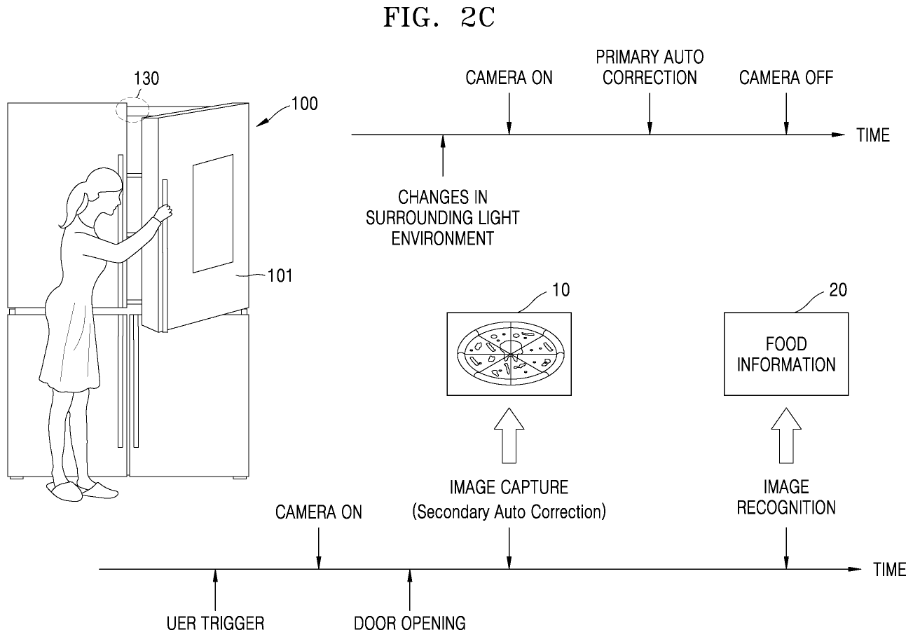

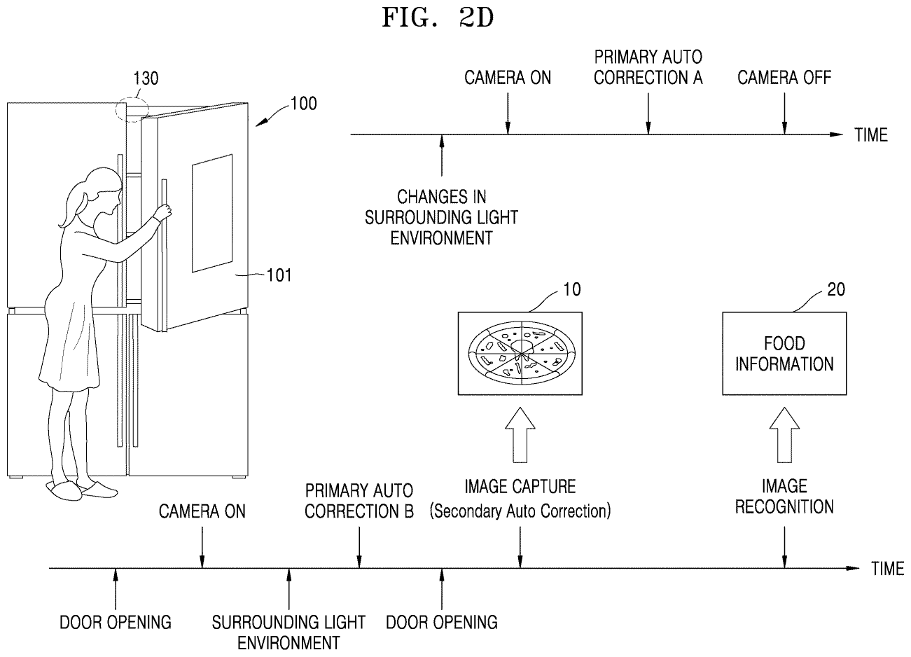

FIG. 2A is a diagram for explaining an overview of an object recognition operation of a home appliance according to an embodiment of the disclosure.

Referring to FIG. 2A, the home appliance 100 according to an embodiment of the disclosure may perform auto correction through the camera 130 depending on changes in a surrounding light environment. For example, the camera 130 may perform at least one of an auto correction operation, such as AE, AWB, and AF operations, by applying the changes in the surrounding light environment.

According to an embodiment of the disclosure, the home appliance 100 may request the camera 130 to capture an image before a door opening event occurs when the surrounding light environment around the home appliance 100 changes. The camera 130 may perform auto correction before the door opening event occurs. The auto correction performed by the camera 130 before the door opening event occurs may be referred to as ‘primary auto correction’, ‘first correction’ or ‘pre-auto correction’. The home appliance 100 according to an embodiment of the disclosure may store a primary correction value based on the primary auto correction of the camera 130.

For example, when changes in the brightness of light around the home appliance 100 occur, the camera 130 may maintain an appropriate exposure value by correcting an exposure time based on changes in brightness according to the AE operation. When the AE operation is stabilized, the camera 130 may provide the exposure value to the home appliance 100 when the AE operation is in a stable state. The home appliance 100 may store in memory a primary exposure value according to primary AE. The primary exposure value may be an exposure value stabilized in response to the brightness of light around the home appliance 100 before the door opening event occurs.

For example, when changes occur in the color temperature of light around the home appliance 100, the camera 130 may maintain white balance by correcting the color temperature based on changes in brightness according to an AWB operation. When the AWB operation is stabilized, the camera 130 may provide a value related to white balance to the home appliance 100 when the AWB operation is in a stable state. For example, a value related to white balance may include a color temperature value. The home appliance 100 may store in memory the primary white balance according to the primary AWB. The primary white balance may be white balance stabilized in response to the brightness of the light around the home appliance 100 before the door opening event occurs.

The home appliance 100 according to an embodiment of the disclosure may perform primary auto correction in response to a surrounding light environment and may then request the camera 130 to capture an image when a door opening event occurs. The camera 130 may perform image capture in which auto correction processing is applied when the door 101 of the home appliance 100 is opened. Auto correction performed by the camera 130 after the door opening event occurs may be referred to as ‘secondary auto correction’ or ‘second correction’. The home appliance 100 according to an embodiment of the disclosure may perform the secondary auto correction by using the primary correction value stored according to the primary auto correction of the camera 130.

For example, when a door opening event occurs, the surrounding light environment around the home appliance 100 may change. For example, when the door opening event occurs, a light (not shown) included in the home appliance 100 is powered on, and the surroundings may become brighter.

The camera 130 has been stabilized in a surrounding light environment around the home appliance 100 according to primary auto correction, and thus the camera 130 may perform a secondary auto correction operation to be stabilized in response to changes in light caused by the door opening event. The camera 130 may perform the secondary auto correction in consideration of an environment of the changed light.

The camera 130 may quickly converge to a target correction value by performing the secondary auto correction by using the primary correction value. For example, the home appliance 100 may provide the primary correction value stored in memory to the camera 130, thereby enabling the camera 130 to use the primary correction value as an initial value (or setting value) of the secondary auto correction. Alternatively, the camera 130 may store the previously obtained primary correction value unless the primary correction value is initialized after the primary auto correction, and thus the primary correction value may be used as the initial value (or setting value) of the secondary auto correction. The camera 130 may be initialized when the camera 130 is powered off from on, but is not limited to the example described above.

For example, the camera 130 may perform a secondary AE operation, based on the stored primary exposure value. The camera 130 may quickly converge to a target exposure value according to the AE operation. The home appliance 100 may perform a secondary AWB operation, based on the stored primary AWB. The camera 130 may quickly converge to a target white balance according to the AWB operation.

The home appliance 100 may more quickly obtain a captured image in which brightness, color tone, color temperature, and the like are appropriately corrected in response to a surrounding light environment by performing secondary auto correction by using a primary correction value as an initial value.

The home appliance 100 may obtain information on at least one object present in the captured image 10 by applying the captured image 10, in which brightness, color tone, color temperature, and the like are appropriately corrected, to an image recognition model. For example, at least one object information may include the food information 20.

In an embodiment of the disclosure, the home appliance 100 may perform primary auto correction according to changes in the surrounding light environment and obtain a captured image, based on the primary correction value, thereby reducing a time required to obtain the captured image.

The home appliance 100 according to an embodiment illustrated in FIG. 2A is exemplified as obtaining and storing a primary correction value by using the camera 130 that is powered on according to a user trigger, but is not limited thereto. An example of the home appliance 100 obtaining and storing the primary correction value is described in more detail with reference to FIGS. 2B, 2C, and 2D.

FIG. 2B is a diagram for explaining an overview of an object recognition operation of a home appliance according to an embodiment of the disclosure.

FIG. 2C is a diagram for explaining an overview of an object recognition operation of a home appliance according to an embodiment of the disclosure.

Referring to FIGS. 2B and 2C, the home appliance 100 according to an embodiment may periodically detect changes in the surrounding light environment, apply power to the camera 130, and obtain the primary correction value. The home appliance 100 may store the primary correction value in memory.

For example, the home appliance 100 may detect changes in the surrounding light environment through at least one sensor. Alternatively, for example, the home appliance 100 may obtain an event indicating changes in the surrounding light environment through an external device.

For example, the home appliance 100 may apply power to the camera 130, based on changes in the surrounding light environment. The camera 130 may perform primary auto correction in response to the surrounding light environment. The home appliance 100 may obtain a primary correction value corresponding to the surrounding light environment from the camera 130 and store the primary correction value.

The home appliance 100 according to an embodiment may obtain the primary correction value and may then provide a power off signal to the camera 130. The camera 130 may perform primary auto correction and may then be powered off. The home appliance 100 may store the primary correction value, based on changes in the surrounding light environment repeatedly before a user trigger or a door opening event occurs.

The home appliance 100 according to an embodiment may perform image capture through the camera 130, based on a door opening event. The home appliance 100 may perform the secondary auto correction by using the primary correction value stored according to the primary auto correction of the camera 130.

For example, referring to FIG. 2B, the home appliance 100 may control the camera 130 to be powered on based on the door opening event. The home appliance 100 may provide a pre-stored primary correction value to the initialized camera 130. The camera 130 may perform the secondary auto correction by using the pre-stored primary correction value. The home appliance 100 may obtain a captured image, to which secondary auto correction is applied, through the camera 130.

For example, referring to FIG. 2C, the home appliance 100 may control the camera 130 to be powered on according to a user trigger. The home appliance 100 may also control the camera 130 to be powered on in advance before the door opening event such that the camera 130 captures an image immediately after the door opening event occurs.

FIG. 2D is a diagram for explaining an overview of an object recognition operation of a home appliance according to an embodiment of the disclosure.

Referring to FIG. 2D, the home appliance 100 according to an embodiment may periodically detect changes in the surrounding light environment, and control the camera 130 to be powered on. The home appliance 100 may obtain a first primary correction value A in response to a first surrounding light environment. The home appliance 100 may store the first primary correction value A. After obtaining the first primary correction value A, the home appliance 100 may provide a power off signal to the camera 130. In the disclosure, the primary correction value obtained through the camera 130 which is powered on according to changes in the surrounding light environment is referred to as the ‘first primary correction value’or ‘A’.

The home appliance 100 according to an embodiment may control the camera 130 to be powered on according to a user trigger. The home appliance 100 may obtain a second primary correction value B in response to a second surrounding light environment. The home appliance 100 may store the second primary correction value B. After obtaining the second primary correction value B, the home appliance 100 may request the camera 130 to capture an image, based on the door opening event. In the disclosure, the primary correction value obtained through the camera 130 that is powered on according to the user trigger is referred to as the ‘second primary correction value’or ‘B’.

In the disclosure, the first surrounding light environment and the second surrounding light environment may be different environments. For example, the surrounding light environment may change depending on changes in sunlight intensity over time, changes in a lighting environment around the home appliance 100, changes in an illumination sensor value, and the like. However, the disclosure is not limited thereto, and the first surrounding light environment and the second surrounding light environment may be the same environment. Accordingly, the first primary correction value and the second primary correction value may be different or the same.

The home appliance 100 according to an embodiment may compare pre-stored primary correction values and provide a comparison result to the camera 130, based on the door opening event. For example, the home appliance 100 may compare the first primary correction value A and the second primary correction value B. The home appliance 100 may set, as the initial value of the camera 130, a primary correction value that is closer to a target correction value among the first primary correction value A and the second primary correction value B. The camera 130 may perform secondary auto correction, based on at least one of the first primary correction value A and the second primary correction value B. The camera 130 may quickly converge to the target correction value by performing secondary auto correction, based on at least one of the first primary correction value A and the second primary correction value B.

Hereinafter, with reference to other drawings, an operation in which the home appliance 100 according to an embodiment of the disclosure performs primary auto correction according to changes in a surrounding light environment and performs secondary auto correction, based on a primary correction value will be described.

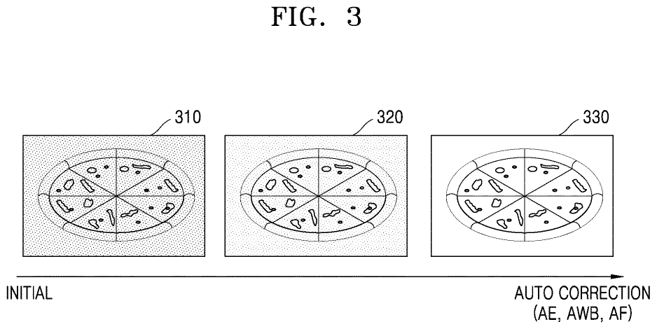

FIG. 3 illustrates examples of a captured image corrected through a camera according to an embodiment of the disclosure.

Referring to FIG. 3, the home appliance 100 may obtain captured images 310, 320, and 330 corresponding to a plurality of frames through the camera 130. A first captured image 310 may be a frame that is first captured through the camera 130. In the order of the first captured image 310, a second captured image 320, and a third captured image 330, an optimal correction value may be converged according to auto correction. The optimal correction value may refer to an exposure value that is suitable for recognizing an object by using an image recognition function or a value related to white balance, based on an image obtained by the camera 130.

For example, when image recognition is performed using the third captured image 330 rather than using the first captured image 310 or the second captured image 320, the accuracy of object recognition may be improved.

For example, the camera 130 may select an appropriate illumination level and exposure time according to an AE operation to consistently maintain a desired brightness and color level. For example, a state in which the AE operation is stabilized may mean a state in which an image distributed at a middle value is obtained when a histogram of brightness distribution of an image obtained by the camera 130 is expressed from 0 to 255. The exposure value in a stable state may correspond to the middle value of the histogram of the brightness distribution. The camera 130 may adjust at least one of a shutter speed, an aperture value, an exposure time, an exposure value, or a gain according to the AE operation.

For example, a captured image to which AE processing is not applied may refer to an image with a long exposure time (overexposed) or a short exposure time (underexposed) and may have an exposure value close to 0 or 255 in the histogram of the brightness distribution.

For example, the camera 130 may maintain a desired color temperature according to an AWB operation. For example, when a component Blue (B) of light irradiated onto a subject is strong, the camera 130 may correct white balance of an image such that the sensitivity to the component B of the light is lowered. Conversely, when the color temperature of the light irradiated on the subject is low and light of Red (R) is strong, the home appliance 100 may correct white balance of an image such that the sensitivity to the component R of the light is lowered.

For example, the captured image to which AWB processing is not applied may mean an image in which the color temperature of light irradiated onto the subject is high or low.

FIG. 4 is a block diagram of a home appliance according to an embodiment of the disclosure.

Referring to FIG. 4, the home appliance 100 may include a processor 110, the memory 120, and the camera 130.

The processor 110 controls the overall operation of the home appliance 100. The processor 110 may be implemented with one or more processors. The processor 110 may execute an instruction or command stored in the memory 120 to perform a predetermined operation. The processor 110 may control the operations of components provided in the home appliance 100. The processor 110 may include at least one of a central processing unit (CPU), a graphics processing unit (GPU), or a neural processing unit (NPU) or a combination thereof.

The processor 110 may be implemented as a main processor (not shown) and a sub processor (not shown) that operates in a sleep mode.

The processor 110 may be connected to the camera 130 via universal serial bus (USB) communication, but is not limited thereto. The home appliance 100 may be described as including a communication interface configured to transmit and receive data with the camera 130.

The processor 110 may be a USB host, may supply powers to a bus, and may detect a connected USB device. The processor 110 may start USB communication with the camera 130 by providing a power on signal to the camera 130 via USB communication. As the processor 110 identifies that the connected USB device is the camera 130, the processor 110 may register camera information at a kernel level. The processor 110 may request the camera 130 to capture an image through a camera application and obtain a frame corresponding to the captured image.

The camera 130 may photograph the inside or outside of the home appliance 100 as described in FIGS. 1, 2A, 2B. 2C, and 2D. The camera 130 may include at least one of auto correction functions, such as AE, AWB, and AF. Power may be applied to the camera 130, based on a user trigger. When the camera 130 receives an image capture request signal from the processor 110, the camera 130 may apply auto correction and perform image capture.

The memory 120 stores various information, data, commands, programs, and the like necessary for the operation of the home appliance 100. The memory 120 may include at least one of volatile memory or non-volatile memory or a combination thereof. The memory 120 may include at least one type of storage medium among flash memory type, hard disk type, multimedia card micro type, card type memory (e.g., SD or XD memory), random access memory (RAM), static random access memory (SRAM), read-only memory (ROM), electrically erasable programmable read-only memory (EEPROM), programmable read-only memory (PROM), magnetic memory, magnetic disk, and optical disk. The memory 120 may correspond to a web storage or cloud server that performs storage functions on the internet.

The processor 110 according to an embodiment executes at least one instruction stored in the memory 120 to control the camera 130 to be powered on based on a user trigger.

The processor 110 according to an embodiment may obtain a user trigger. The user trigger may include various information for powering on the camera 130 in advance and preparing to perform image capture before a door opening event of the home appliance 100 occurs.

For example, the user trigger may include information that the user approaches the home appliance 100. For example, the processor 110 may obtain the user trigger corresponding to the user approaching the home appliance 100 through at least one sensor. For example, the processor 110 may control the camera 130 to be powered on upon receiving the information about the user approaching the home appliance 100 through a proximity sensor. The proximity sensor may detect that the user approaches the home appliance 100. This may be seen as a user trigger to power on the camera 130 when the user approaches the home appliance 100.

For example, the user trigger may include information about whether the user touches a handle located on a door of the home appliance 100. For example, the processor 110 may obtain whether the user touches the handle or a predetermined touch pressure through a handle sensor located on the door of the home appliance 100. The processor 110 may identify the user trigger, based on whether the user touches the handle or a predetermined touch pressure, which is obtained through the handle sensor, and control the camera 130 to be powered on.

For example, the user trigger may include information based on a human body detection event in a house including the home appliance 100. For example, the processor 110 may obtain the user trigger, based on the human body detection event obtained from an external device connected under the same account as the home appliance 100. For example, a server may manage external devices connected under the same account as the home appliance 100. When the server detects that there is a person in the house through an external device (i.e., a human body detection event occurs), the server may transmit a power on signal of the camera 130 to the home appliance 100 through a communication module in response to the human body detection event. The home appliance 100 may determine the power on signal of the camera 130, received from the server, as the user trigger and control the camera 130 to be powered on.

The processor 110 according to an embodiment may provide the power on signal to the camera 130, based on a user trigger. For example, the processor 110 may provide the power on signal to the camera 130 via USB communication.

The processor 110 according to an embodiment may execute at least one instruction stored in the memory 120 to perform primary auto correction, through the camera 130, in response to a surrounding light environment around the home appliance 100. The processor 110 may store a primary correction value according to the primary auto correction. For example, the primary auto correction may be auto correction performed before a door opening event of the home appliance 100 occurs.

For example, the surrounding light environment around the home appliance 100 may include at least one of a lighting condition of an external device located around the home appliance 100, sunlight intensity for each time zone, and an illumination level around the home appliance 100.

For example, the processor 110 may obtain a surrounding light environment change event around the home appliance 100. The light environment change event may include on/off changes of lighting of an external device located around the home appliance 100, changes in sunlight intensity for each time zone, and changes in illumination level around the home appliance 100.

For example, the processor 110 may obtain a lighting condition change event around the home appliance 100 through the server. For example, the processor 110 may obtain the surrounding light environment change event around the home appliance 100 in response to an event in which at least one lighting in an identical space to the home appliance 100 is turned on or off. For example, the processor 110 may obtain the surrounding light environment change event around the home appliance 100 in response to at least one of a first lighting change event in which all lighting in a space adjacent to the home appliance 100 is turned off and a second lighting change event in which a state where all lightings are turned off changes to a state where at least one lighting is turned on.

For example, the processor 110 may identify the light environment change event, based on changes in sunlight intensity for each predetermined time zone. For example, the processor 110 may identify changes in sunlight intensity at sunrise, noon (12:00), sunset, and midnight (00:00), and perform primary auto correction, based on sunlight intensity for each time zone.

The processor 110 according to an embodiment may transmit an image capture request signal to the camera 130 upon obtaining the surrounding light environment change event. The camera 130 may perform primary auto correction in response to the image capture request signal. For example, the camera 130 may correct exposure and/or white balance in response to the surrounding light environment (lighting condition, sunlight intensity, illumination level, or the like). The camera 130 may store a primary correction value corresponding to the surrounding light environment. The camera 130 may provide the primary correction value to the processor 110. The processor 110 may store, in the memory 120, the primary correction value corresponding to the surrounding light environment of the camera 130.

The processor 110 according to an embodiment may execute at least one instruction stored in the memory 120 to obtain a captured image to which auto correction of the camera 130 is applied, based on a door opening event of the home appliance 100. For example, the auto correction may be secondary auto correction performed after the door opening event of the home appliance 100 occurs.

For example, the processor 110 may transmit an image capture request signal to the camera 130 based on a door opening event of the home appliance 100. The camera 130 may perform secondary auto correction in response to the image capture request signal. The camera 130 may perform secondary auto correction by using a primary correction value as an initial value (or setting value) in response to the surrounding light environment (lighting condition, sunlight intensity, illumination level, or the like). The camera 130 may use the primary correction value adapted to the surrounding light environment around the home appliance 100 as an initial value, and thus may quickly converge to a target correction value corresponding to changes in the surrounding light environment based on opening of the door.

The processor 110 according to an embodiment may execute at least one instruction stored in the memory 120 to obtain object information of at least one object recognized from a captured image. The captured image to which secondary auto correction processing is applied may have exposure values or white balance values suitable for object recognition. For example, pixels in a captured image to which the secondary correction value is applied may have a greater distribution of middle grey than pixels in a captured image to which the primary auto correction value is applied.

In the disclosure, the captured image is exemplified as being processed for image recognition in the home appliance 100, but is not limited thereto. For example, the home appliance 100 may transmit the captured image to a server, the captured image is processed for image recognition through an image recognition model installed on the server, and the home appliance 100 may also receive object information from the server.

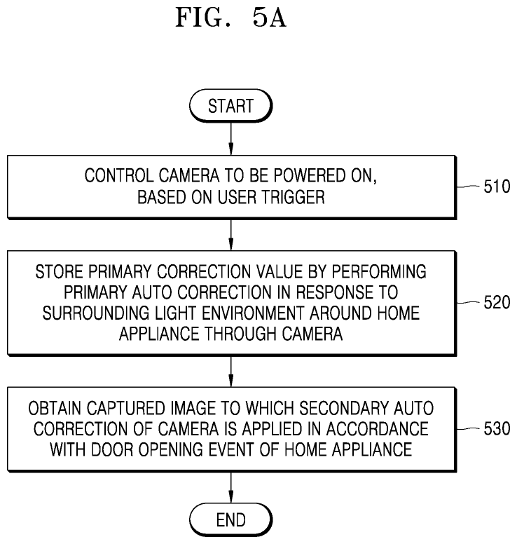

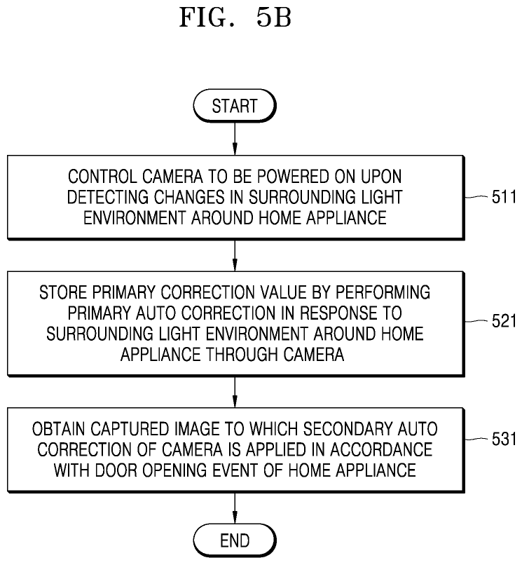

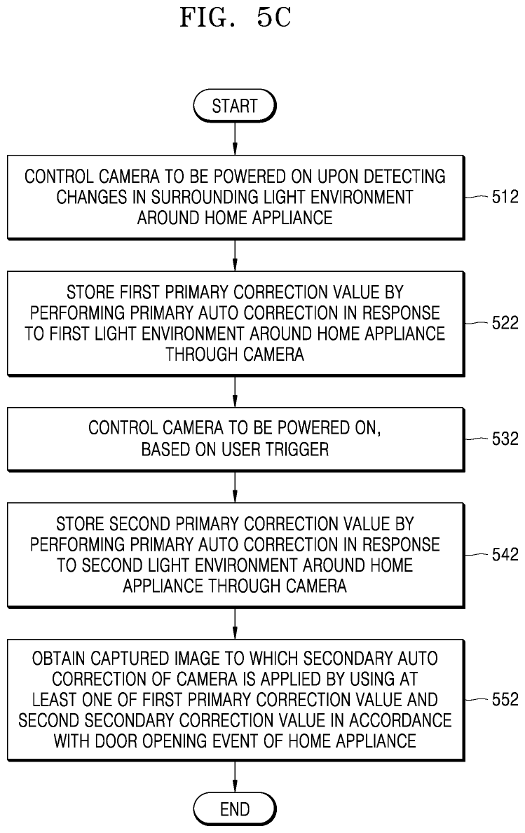

FIG. 5A is a flowchart for explaining an operation in which a home appliance obtains a captured image through a camera, according to an embodiment of the disclosure.

Referring to FIG. 5A, in operation 510, the home appliance 100 according to an embodiment may control the camera 130 to be powered on, based on a user trigger.

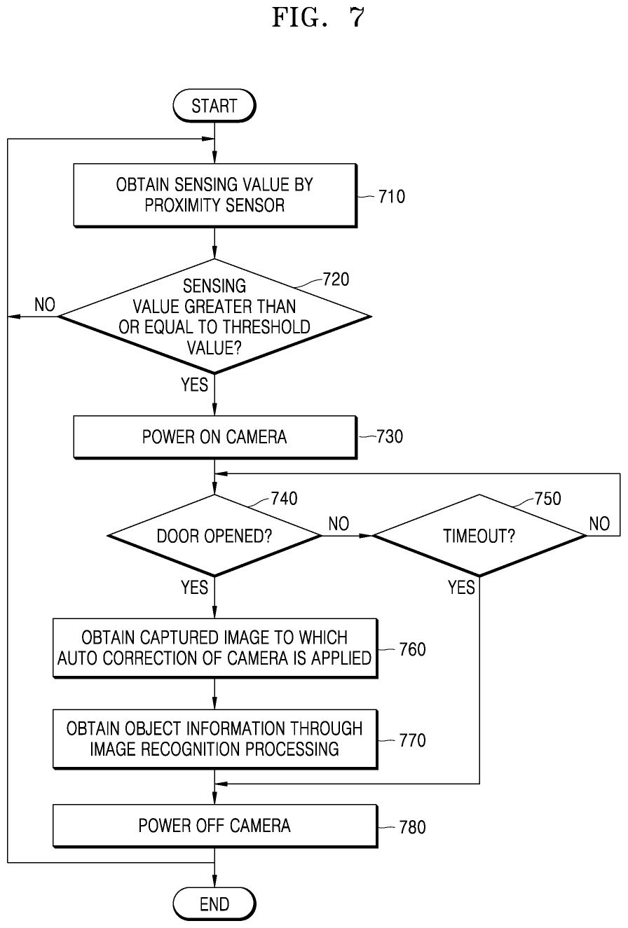

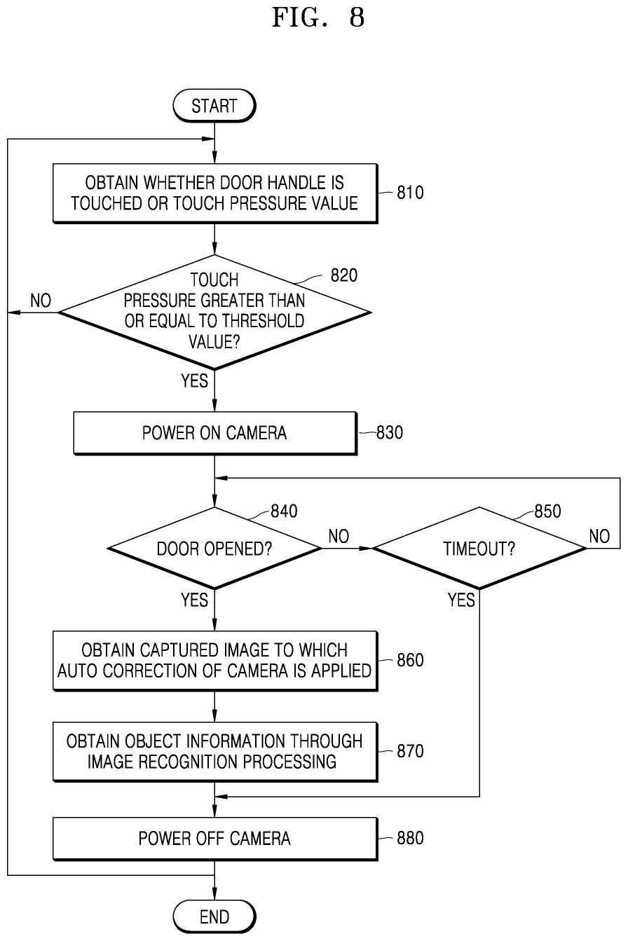

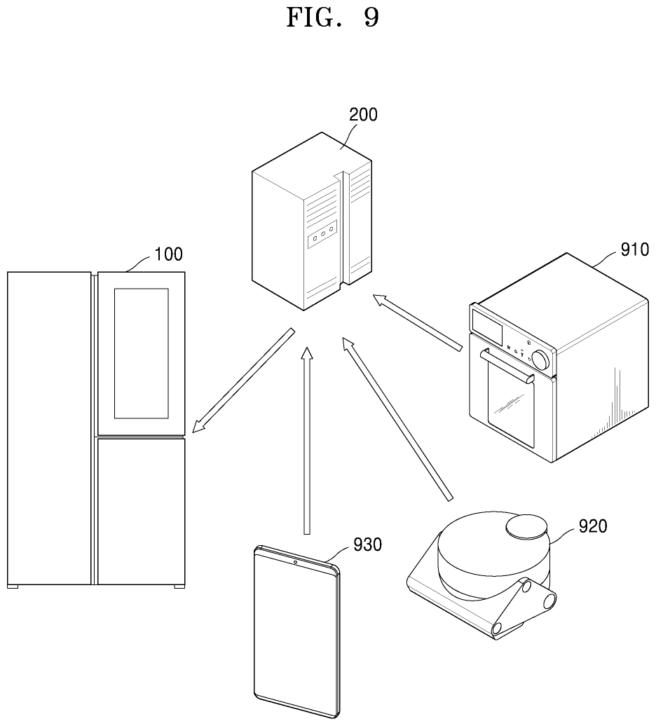

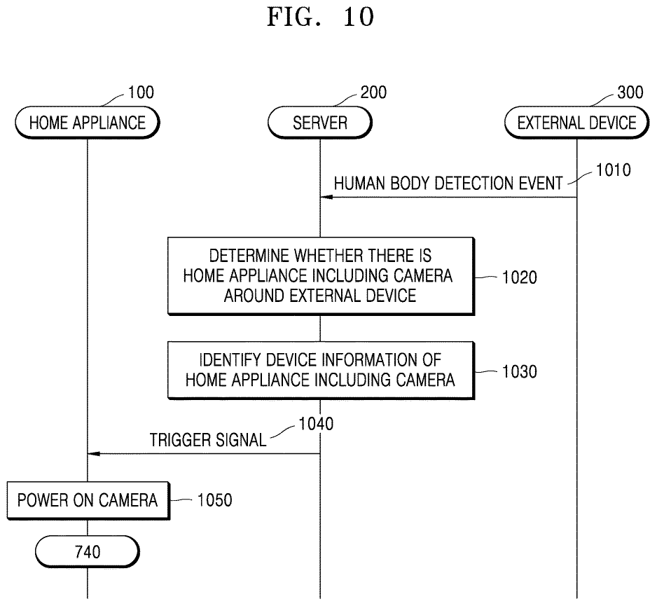

The home appliance 100 may obtain a user trigger. The user trigger may include various information for powering on the camera 130 in advance and preparing to perform image capture before a door opening event of the home appliance 100 occurs. For example, the user trigger may include information that the user approaches the home appliance 100 (refer to FIGS. 6 and 7). For example, the user trigger may include information about whether the user touches a handle located on a door of the home appliance 100 (refer to FIGS. 6 and 8). For example, the user trigger may include information about detection of a person in a house including the home appliance 100 (i.e., a human body detection event occurs) (refer to FIGS. 9 and 10).

The home appliance 100 may provide the power on signal to the camera 130, based on a user trigger. For example, the home appliance 100 may provide the power on signal to the camera 130 via USB communication. The camera 130 may be powered on before a door opening event occurs.

In operation 520, the home appliance 100 according to an embodiment may store a primary correction value by performing primary auto correction, through the camera 130, in response to a surrounding light environment around the home appliance 100. For example, the primary auto correction may be pre-auto correction performed before a door opening event of the home appliance 100 occurs.

For example, the surrounding light environment around the home appliance 100 may include at least one of a lighting condition of an external device located around the home appliance 100, sunlight intensity for each time zone, and an illumination level around the home appliance 100.

The home appliance 100 may obtain a surrounding light environment change around the home appliance 100. The light environment change event may include on/off changes of lighting of an external device located around the home appliance 100, changes in sunlight intensity for each time zone, and changes in illumination level around the home appliance 100.

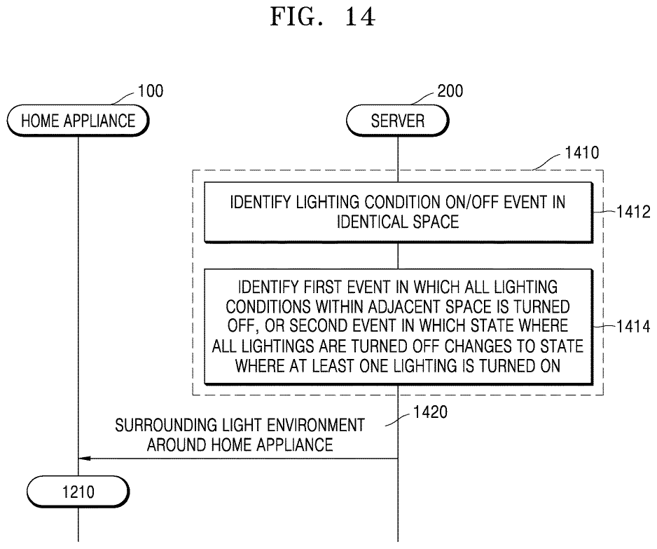

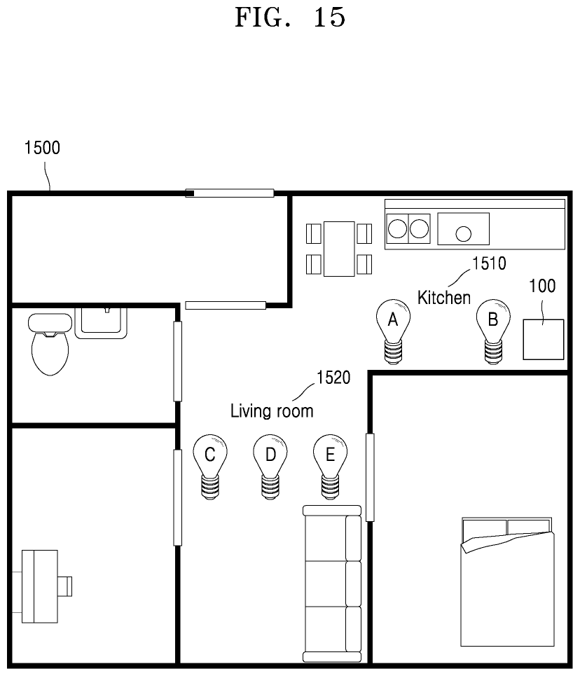

For example, the home appliance 100 may obtain a surrounding light environment change event around the home appliance 100 through the server. For example, when the server obtains an event in which a lighting in an identical space or an adjacent space to the home appliance 100 is turned on or off, the server may provide the home appliance 100 with the surrounding light environment change event around the home appliance 100 (refer to FIGS. 14 and 15).

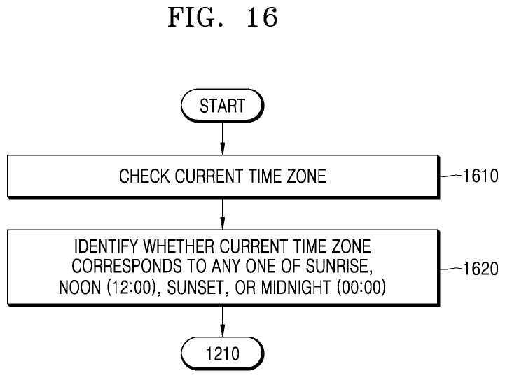

For example, the home appliance 100 may identify the light environment change event, based on changes in sunlight intensity for each predetermined time zone (refer to FIG. 16).

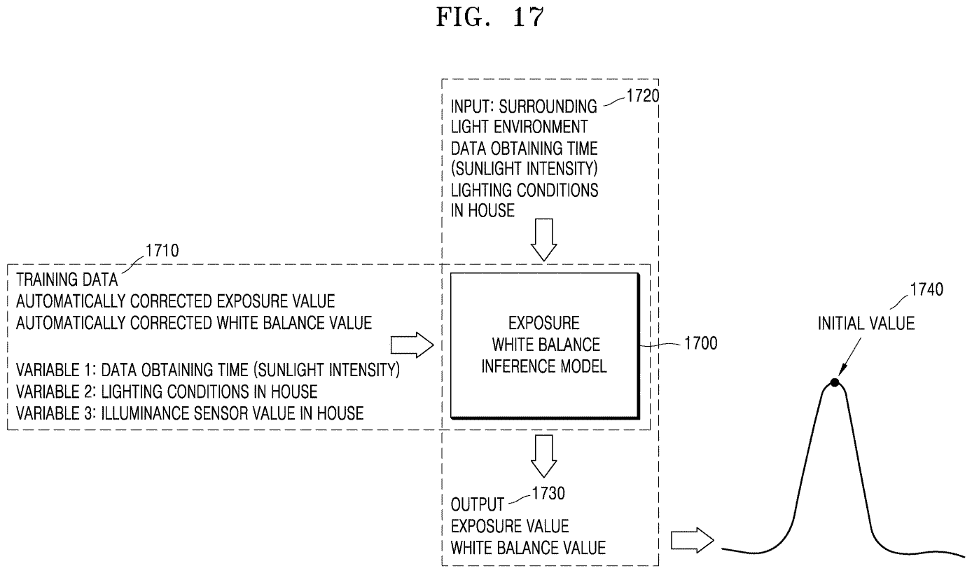

For example, the home appliance 100 may obtain a primary correction value by using an exposure inference model or a white balance inference model. The home appliance 100 may obtain an exposure value and white balance stabilized in response to the surrounding light environment by inputting information about the surrounding light environment around the home appliance 100 to the exposure inference model or the white balance inference model (refer to FIG. 17). A value output by the exposure inference model or the white balance inference model may be used as a primary correction value. In this case, the primary auto correction operation of the camera 130 may be omitted.

The home appliance 100 may transmit an image capture request signal to the camera 130 upon obtaining the surrounding light environment change event. The camera 130 may perform primary auto correction in response to the image capture request signal. The camera 130 may provide a primary correction value to the processor 110 in response to the surrounding light environment. The processor 110 may store, in the memory 120, the primary correction value corresponding to the surrounding light environment of the camera 130.

For example, the camera 130 may correct exposure and/or white balance in response to the surrounding light environment (lighting condition, sunlight intensity, illumination level, or the like). For example, the camera 130 may obtain an appropriate exposure value for the surrounding light environment by performing AE, based on the surrounding light environment. The camera 130 may obtain an appropriate white balance for the surrounding light environment by performing AWB, based on the surrounding light environment. The camera 130 may transfer a pre-exposure value and pre-white balance to the processor 110, and the processor 110 may store the pre-exposure value and the pre-white balance.

In operation 530, the home appliance 100 according to an embodiment may obtain a captured image to which secondary auto correction of the camera 130 is applied based on a door opening event of the home appliance 100. For example, the auto correction may be auto correction performed after the door opening event of the home appliance 100 occurs.

The home appliance 100 may obtain a door opening event. The processor 110 may transmit an image capture request signal to the camera 130 based on the door opening event. The camera 130 may perform auto correction in response to the image capture request signal. The camera 130 may perform auto correction by using a primary correction value as an initial value in response to the surrounding light environment (lighting condition, sunlight intensity, illumination level, or the like).

For example, pixels in a captured image to which secondary correction is applied may have a greater distribution of middle grey than pixels in a captured image to which the primary correction is applied. For example, a correction value (secondary correction value) applied to the captured image based on a door opening event may be closer to a target correction value than a pre-corrected correction value (primary correction value). For example, the secondary exposure value applied to the captured image based on the door opening event may be greater or smaller than the primary exposure value. For example, the color temperature set in the secondary white balance applied to the captured image based on the door opening event may be higher or lower than the color temperature set in the primary correction white balance.

For example, when the door opening event occurs, a light element due to a lighting of the home appliance 100 may be added to the home appliance 100. The camera 130 may use the pre-correction value adapted to the surrounding light environment around the home appliance 100 as an initial value, and thus may quickly converge to a target correction value obtained by further considering a light element due to a lighting of the home appliance 100.

The home appliance 100 according to an embodiment of the disclosure may immediately perform image capture when a door opening event occurs by controlling the camera 130 to be powered on based on a user trigger.

The home appliance 100 according to an embodiment of the disclosure may perform primary auto correction of the camera 130, based on changes in the surrounding light environment and store the primary correction value. The home appliance 100 may perform secondary auto correction, based on a door opening event. The camera 130 may perform secondary auto correction by using a pre-stored primary correction value as an initial value, and thus may quickly converge to a target correction value required for accurate image recognition processing.

FIG. 5B is a flowchart for explaining an operation in which a home appliance obtains a captured image through a camera, according to an embodiment of the disclosure. In FIG. 5B, a repeated description of FIG. 5A is omitted.

Referring to FIG. 5B, in operation 511, the home appliance 100 according to an embodiment may control the camera 130 to be powered on upon detecting changes in a surrounding light environment around the home appliance 100.

For example, the home appliance 100 may detect changes in the surrounding light environment through at least one sensor. Alternatively, for example, the home appliance 100 may obtain an event indicating changes in the surrounding light environment through an external device.

In operation 521, the home appliance 100 according to an embodiment may store a primary correction value by performing primary auto correction, through the camera 130, in response to a surrounding light environment around the home appliance 100. The primary correction value may be stored in the memory 120. The home appliance 100 may store a primary correction value and power off the camera 130.

The home appliance 100 according to an embodiment may periodically perform operations 511 and 521.

In operation 531, the home appliance 100 according to an embodiment may obtain a captured image to which secondary auto correction of the camera 130 is applied based on a door opening event of the home appliance 100.

For example, the home appliance 100 may control the camera 130 to be powered on based on the door opening event. The home appliance 100 may provide a pre-stored primary correction value to the initialized camera 130. The camera 130 may perform the secondary auto correction by using the pre-stored primary correction value. The home appliance 100 may obtain a captured image, to which secondary auto correction is applied, through the camera 130.

For example, the home appliance 100 may control the camera 130 to be powered on according to a user trigger. The home appliance 100 may also control the camera 130 to be powered on in advance before the door opening event such that the camera 130 captures an image immediately after the door opening event occurs.

FIG. 5C is a flowchart for explaining an operation in which a home appliance obtains a captured image through a camera, according to an embodiment of the disclosure.

In FIG. 5C, a repeated description of FIG. 5A or 5B is omitted.

Referring to FIG. 5C, in operation 512, the home appliance 100 according to an embodiment may control the camera 130 to be powered on upon detecting changes in a surrounding light environment around the home appliance 100.

In operation 522, the home appliance 100 according to an embodiment may store a first primary correction value by performing primary auto correction, through the camera 130, in response to a first light environment around the home appliance 100. The home appliance 100 may power off the camera 130.

In operation 532, the home appliance 100 according to an embodiment may control the camera 130 to be powered on, based on a user trigger.

In operation 542, the home appliance 100 according to an embodiment may store a second primary correction value by performing primary auto correction, through the camera 130, in response to a second light environment around the home appliance 100.

The first surrounding light environment and the second surrounding light environment may be different environments or the same environment. Accordingly, the first primary correction value and the second primary correction value may be different or the same.

In operation 552, the home appliance 100 according to an embodiment may obtain a captured image to which secondary auto correction of the camera 130 is applied by using at least one of the first primary correction value and the second secondary correction value based on a door opening event of the home appliance 100. The home appliance 100 may set, as an initial value of the camera 130, at least one of the first primary correction value and the second secondary correction value. The camera 130 may perform secondary auto correction, based on at least one of the first primary correction value and the second secondary correction value.

FIG. 6 is a diagram showing a structure in which a home appliance includes a sensor, according to an embodiment of the disclosure.

Referring to FIG. 6, the home appliance 100 according to an embodiment may further include at least one sensor 140 and 150.

For example, referring to 601, the home appliance 100 may include a proximity sensor 140. The proximity sensor 140 may detect a degree of proximity to a surrounding object or an object. For example, the proximity sensor 140 may include a passive infrared sensor (PIR) sensor that identifies an object within a viewing angle of a sensor by using infrared light. For example, when the PIR sensor is installed at an upper end of the home appliance 100, a viewing angle may be determined according to an angle at which the PIR sensor is installed. For example, the proximity sensor 140 may be located between doors 101a and 101b of the home appliance 100, but is not limited thereto. For example, the proximity sensor 140 may be located close to the camera 130, but is not limited thereto.

The home appliance 100 may determine whether a user is close to the home appliance 100 through the proximity sensor 140. The proximity sensor 140 may detect a user who is close to the home appliance 100 or detect a degree of proximity of the user.

For example, referring to 602, the home appliance 100 may include a handle sensor 150. The handle sensor 150 may detect whether a user touches the doors 101a and 101b or a handle of the doors 101a and 101b or a touch pressure. For example, the handle sensor 150 may be located on the handle of the doors 101a and 101b.

The home appliance 100 may determine whether the user touches the handle of the home appliance 100 through the handle sensor 150. The home appliance 100 may determine that a touch exists when the touch pressure obtained through the handle sensor 150 is greater than or equal to a predetermined value.

FIG. 7 is a flowchart for explaining an operation in which a home appliance obtains a user trigger through a sensor, according to an embodiment of the disclosure.

Referring to FIG. 7, in operation 710, the home appliance 100 may obtain a sensing value through the proximity sensor 140. For example, the proximity sensor 140 may detect a degree of proximity to a surrounding object around the home appliance 100 or an object and transmit the sensing value to the processor 110.

In operation 720, the home appliance 100 may identify whether the sensing value is greater than or equal to a threshold value. The processor 110 determines that the user approaches the home appliance 100 when the sensing value is greater than or equal to a threshold value. The processor 110 determines that the user does not approach the home appliance 100 when determining that the sensing value is less than the threshold value.

In operation 730, the home appliance 100 may control the camera 130 to be powered on when the sensing value is greater than or equal to the threshold value. The processor 110 may identify information that the user approaches the home appliance 100 as a user trigger and control the camera 130 to be powered on. Based on information obtained through the proximity sensor 140, the home appliance 100 may start preparing the camera 130 in advance when the user is located in front of the home appliance 100.

In operation 740, the home appliance 100 may identify whether a door opening event occurs. For example, the home appliance 100 may identify whether the door opening event occurs through a door opening detection sensor present in the home appliance 100, but is not limited thereto.

In operation 750, when the home appliance 100 determines that a door opening event does not occur and that a predetermined time elapses, the home appliance 100 may control the camera 130 to be powered off according to operation 780. Alternatively, when the home appliance 100 determines that a door opening event does not occur and that a predetermined time does not elapse, the home appliance 100 may identify again whether the door opening event occurs.

In operation 760, the home appliance 100 may obtain a captured image to which auto correction of the camera 130 is applied, when the door opening event occurs. The processor 110 may provide an image capture request signal to the camera 130 based on the door opening event. The camera 130 may transfer, to the processor 110, a captured image to which auto correction is applied. The captured image may be an image to which both primary auto correction and secondary auto correction are applied, or an image to which only secondary auto correction is applied.

In operation 770, the home appliance 100 may obtain at least one object information from a captured image through image recognition processing. For example, image recognition processing may be performed through an artificial intelligence model. The artificial intelligence model may output at least one object information included in the captured image by using a captured image as input. The artificial intelligence model may correspond to a neural network model trained using various food-related data as training data. The captured image may have an exposure value or white balance-related value suitable for object recognition by using image recognition processing.

In operation 780, the home appliance 100 may control the camera 130 to be powered off upon obtaining object information.

FIG. 8 is a flowchart for explaining an operation in which a home appliance obtains a user trigger through a sensor, according to an embodiment of the disclosure.

In FIG. 8, a repeated description of FIG. 7 is briefly explained.

Referring to FIG. 8, in operation 810, the home appliance 100 may obtain, through the handle sensor 150, whether a door handle of the home appliance 100 is touched or a touch pressure value. For example, the handle sensor 150 may transfer, to the processor 110, information about whether a touch occurs or a touch pressure value when a user touches the door handle.

In operation 820, the home appliance 100 may identify whether the touch pressure is greater than or equal to a threshold value. When the processor 110 determines that the touch pressure is greater than or equal to the threshold value, the processor 110 may identify a user trigger, considering that the user is about to open the door of the home appliance 100. When the processor 110 determines that the touch pressure is less the threshold value, the processor 110 may not identify this as the user trigger. Alternatively, the home appliance 100 may identify whether a touch is present and, when a touch is present, identify this as a user trigger.

In operation 830, the home appliance 100 may control the camera 130 to be powered on when the touch pressure is greater than or equal to the threshold value or a touch is present. The home appliance 100 may start preparing the camera 130 in advance when the user grabs the door, based on information obtained through the handle sensor 150.

In operation 840, the home appliance 100 may identify whether a door opening event occurs.

In operation 850, when the home appliance 100 determines that a door opening event does not occur and that a predetermined time elapses, the home appliance 100 may control the camera 130 to be powered off according to operation 880.

In operation 860, the home appliance 100 may obtain a captured image to which auto correction of the camera 130 is applied, when the door opening event occurs.

In operation 870, the home appliance 100 may obtain at least one object information from a captured image through image recognition processing.

In operation 880, the home appliance 100 may control the camera 130 to be powered off upon obtaining object information.

FIG. 9 is a diagram showing external devices registered on a server under the same account as a home appliance, according to an embodiment of the disclosure.

Referring to FIG. 9, the home appliance 100 may be connected to a network through an AP device (not shown) in a house and may communicate with a server 200 or an external device. The home appliance 100 may include a communication module. For example, the home appliance 100 may communicate indirectly with an external device through the server 200 in a Device to Server (D2S) manner. Alternatively, for example, the home appliance 100 may communicate directly with an external device in a Device to Device (D2D) manner.

The external device may correspond to various types of electronic devices having a communication function. For example, the external device may have a form of a mobile device. In addition, the external device may correspond to a smartphone, a wearable device, a tablet PC, an oven, a smart cooking appliance, a refrigerator, a smart home hub, or the like. In FIG. 9, external devices 910, 920, and 930 are exemplified as including an oven 910, a robot vacuum cleaner 920, and a user terminal 930.

According to an embodiment of the disclosure, the external devices 910, 920, and 930 may be connected to the server 200 by using the same user identification information (e.g., login information or account information) as the home appliance 100.

The server 200 may include a communication module for communicating with an external device. The server 200 may also communicate with the home appliance 100 or the external devices 910, 920, and 930 through the communication module. The server 200 may update software of the home appliance 100, based on communication with the home appliance 100, or transfer the updated software related to the home appliance 100, based on communication with the external devices 910, 920, and 930.

Hereinafter, with reference to FIG. 10, an operation is described in which the external devices 910, 920, and 930 located in a house, such as the home appliance 100, determines whether there is a user in the house, and when there is the user, provides a user trigger to the home appliance 100 such that the home appliance 100 powers on the camera in advance and prepares.

In an embodiment of the disclosure, the external devices 910, 920, and 930 may identify whether a human body is present around the external devices 910, 920, and 930. When the external devices 910, 920, and 930 identify a human body detection event, the external devices 910, 920, and 930 may transfer information about the human body detection event to the server 200. Based on information about the human body detection event, the server 200 may identify that there is a user in the house in which the external devices 910, 920, and 930 are located.

FIG. 10 is a flowchart for explaining an operation in which a home appliance obtains a user trigger through a human body detection event in a house, according to an embodiment of the disclosure.

Referring to FIG. 10, in operation 1010, the external device 300 may transfer, to the server 200, information about a human body detection event. The server 200 may receive information about the human body detection event from the external device 300. The server 200 may determine that there is a person in the house through the human body detection event.

The external device 300 may be connected under the same account as the home appliance 100 and may be located in the house of the home appliance 100.

For example, the external device 300 may identify that the human body detection event occurs corresponding to global positioning system (GPS) location information, touch input to the external device 300, information obtained from a human body detection sensor of an entrance door inside the house, or the like. The human body detection event is not limited to the example described above.

For example, the server 200 may determine that there is a person in the house when the GPS location information of the external device 300 received from the external device 300 is in the house. For example, the server 200 may determine that there is a person in the house when there is a touch input on the external device 300 inside the house. For example, the server 200 may determine that there is a person in the house upon detecting a human body through the human body detection sensor of an entrance door in the house.

For example, when there is no human detection in the house for a reference time or more, the server 200 may determine that there is no person in the house.

In operation 1020, the server 200 may determine whether there is the home appliance 100 including a camera around the external device 300 upon receiving information about a human body detection event from the external device 300.

For example, the server 200 may receive information related to the external device 300 that transmits the human body detection event, and for example, the server 200 may receive device information, location information, IP information, and the like of the external device 300. Information related to a device registered to the same account may be stored in a database of the server 200. The server 200 may determine whether there is the home appliance 100 including a camera around the external device 300, based on information related to the external device 300. For example, when the server 200 receives the human body detection event from an oven located in a kitchen, the server 200 may determine whether there is the home appliance 100 including a camera in the kitchen through the location information of the oven.

In operation 1030, the server 200 may identify the device information of the home appliance 100 including the camera.

For example, the server 200 may identify the device information of the home appliance 100 when determining that there is the home appliance 100 including the camera among the home appliances located around the external device 300. The server 200 may identify the device information of the home appliance 100 by using the device information registered to the same account stored in the database. For example, the server 200 may identify the device information of the home appliance 100 including the camera located in the kitchen, which is the same location as the oven.

In operation 1040, the server 200 may transmit a trigger signal to the home appliance 100 corresponding to the identified device information. The home appliance 100 may receive the trigger signal from the server 200.

In operation 1050, the home appliance 100 may control the camera to be powered on upon receiving the trigger signal from the server 200. The home appliance 100 may determine the trigger signal received from the server 200 in response to a human body detection event as a user trigger and start a preparation operation of the camera.

The home appliance 100 may control the camera to be powered on in response to receiving, via a communication module, information indicating a human body detection event from the external device 300 connected under the same account as the home appliance 100. The trigger signal obtained from the server 200 may correspond to a user trigger for camera preparation.

The home appliance 100 may quickly perform image capture through the camera that is powered on when a door opening event occurs, as in operation 740 of FIG. 7.

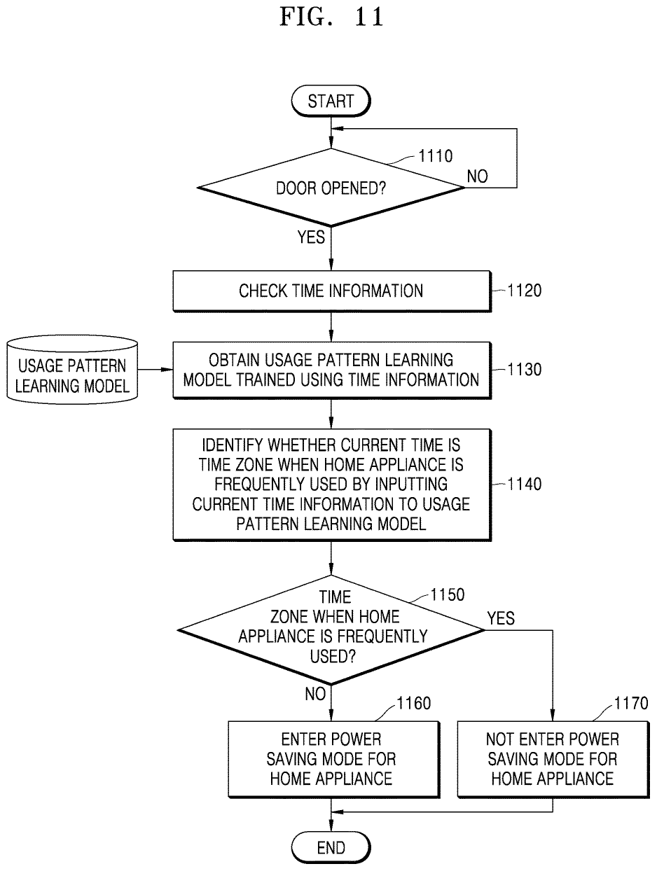

FIG. 11 is a flowchart for determining whether to enter a power saving mode based on a usage pattern of a home appliance, according to an embodiment of the disclosure.

Referring to FIG. 11, in operation 1110, the home appliance 100 may identify whether a door opening event occurs.

In operation 1120, the home appliance 100 may check time information of when the door opening event occurs when the door opening event occurs. When a user uses the home appliance 100, the door opening event of the home appliance 100 may occur. Accordingly, time information of the door opening event may correspond to information about a time zone when the user uses the home appliance 100.

In operation 1130, the home appliance 100 may obtain a usage pattern learning model trained using time information when a door opening event occurs. The home appliance 100 may obtain the usage pattern learning model that learns the usage pattern of the home appliance 100 by using a time zone when the user frequently uses the home appliance 100 or a frequency of use of the home appliance 100. The home appliance 100 may train a usage pattern learning model by using time information of when a door opening event occurs as training data. The usage pattern learning model may be an artificial intelligence model.

The artificial intelligence model may be processed by an AI-dedicated processor designed with a hardware architecture specialized for processing the artificial intelligence model. Training an artificial intelligence model may mean generating a mathematical model for inferring an optimal result by appropriately changing a weight, based on input training data.

The usage pattern learning model may infer the usage pattern of the user for the home appliance 100, such as a time zone when the home appliance 100 is frequently used or a frequency of use of the home appliance 100.

The home appliance 100 may store a trained usage pattern learning model in the memory 120 by using, as training data, time information of when a door opening event occurs.

In operation 1140, the home appliance 100 may identify whether the current time is a time zone when the home appliance 100 is frequently used by inputting current time information to a usage pattern learning model. When the usage pattern learning model receives current time information, the home appliance 100 may output a result regarding whether the current time information is a time zone when the home appliance 100 is frequently used.

In operation 1150, the home appliance 100 may identify whether the current time corresponds to a time zone when the home appliance 100 is frequently used.

In operation 1160, the home appliance 100 may enter a power saving mode for the home appliance 100 when the current time does not correspond to a time zone in which the home appliance 100 is frequently used.

In operation 1170, the home appliance 100 may not enter a power saving mode for the home appliance 100 due to the current time corresponding to a time zone in which the home appliance 100 is frequently used. The home appliance 100 may operate in a normal mode.

The home appliance 100 according to an embodiment may execute a power saving mode (or low power mode) to reduce power consumption when the home appliance 100 is not used. The home appliance 100 operating in a power saving mode may wake up from the power saving mode and enter a normal mode upon obtaining a user trigger. After the home appliance 100 enters the normal mode, the home appliance 100 may provide a power on signal to the camera 130. Accordingly, when the home appliance 100 obtains the user trigger in a power saving mode, the home appliance 100 may take a time to power on the home appliance 100.

The home appliance 100 according to an embodiment may obtain the usage pattern learning model that learns the usage pattern of the home appliance 100 by using a time zone when the user frequently uses the home appliance 100 or a frequency of use of the home appliance 100. The home appliance 100 may determine whether the home appliance 100 enters a power saving mode by using a usage pattern learning model.

According to an embodiment, the home appliance 100 may omit an operation of waking up from a power saving mode, based on a user trigger, by executing a normal mode when the current time is a time zone when the home appliance 100 is frequently used. As the operation of waking from a sleep mode based on a user trigger is omitted, a preparation time to turn on the camera may be reduced.

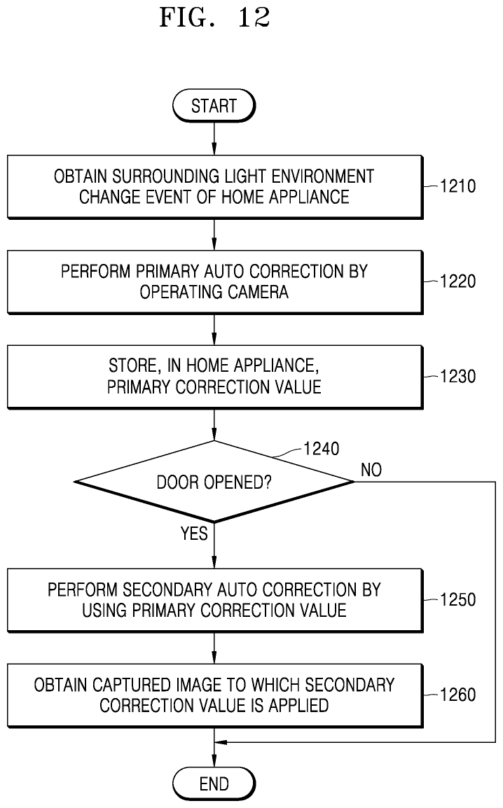

FIG. 12 is a flowchart for explaining an operation for performing auto correction on a captured image, based on changes in a surrounding light environment of a home appliance, according to an embodiment of the disclosure.

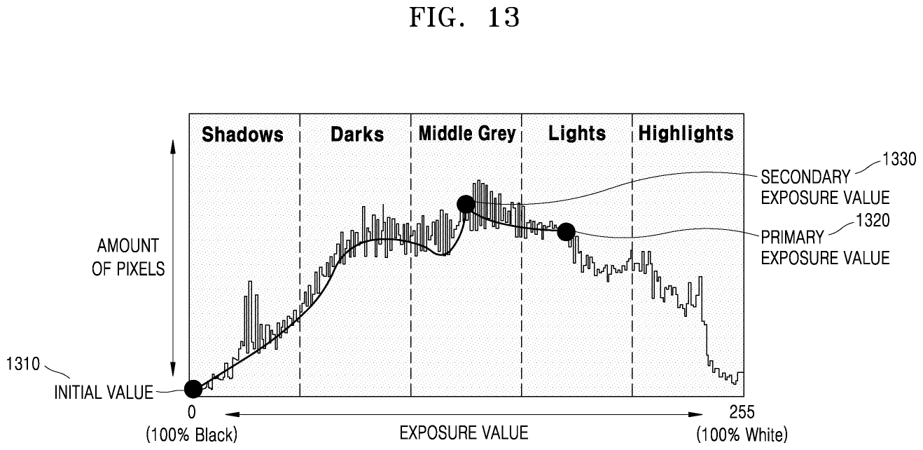

FIG. 13 is a graph showing exposure values obtained through AE of a camera, according to an embodiment of the disclosure.

Referring to FIG. 12, in operation 1210, the home appliance 100 may obtain a surrounding light environment change event of the home appliance 100.

The surrounding light environment change event of the home appliance 100 may include on/off changes of a lighting of an external device located around the home appliance 100, changes in sunlight intensity for each time zone, and changes in illumination level around the home appliance 100. This is described with reference to FIGS. 14 to 17.

In operation 1220, the home appliance 100 may perform primary auto correction by operating the camera 130 upon obtaining the surrounding light environment change event.

For example, the home appliance 100 may transmit an image capture request signal to the camera 130 upon obtaining the surrounding light environment change event. The camera 130 may perform primary auto correction in response to the image capture request signal. For example, the camera 130 may correct exposure and/or white balance in response to the surrounding light environment (lighting condition, sunlight intensity, illumination level, or the like).

For example, the camera 130 may obtain a primary exposure value by performing AE in response to the surrounding light environment. For example, the camera 130 may obtain primary white balance by performing AWB in response to the surrounding light environment. The camera 130 may store a primary correction value including the primary exposure value and primary white balance in response to the surrounding light environment.

When auto correction is stabilized, the camera 130 may provide, to the processor 110, the primary correction value corresponding to a stable state. For example, when the AE operation is stabilized, the camera 130 may provide the exposure value to the processor 110 when the AE operation is in a stable state. When the AWB operation is stabilized, the camera 130 may provide a value related to white balance to the processor 110 when the AWB operation is in a stable state.

In operation 1230, the home appliance 100 may store, in the home appliance 100, a primary correction value corresponding to the surrounding light environment. For example, the processor 110 may store, in the memory 120, the primary correction value obtained from the camera 130.

In operation 1240, the home appliance 100 may identify whether a door opening event occurs.

In operation 1250, the home appliance 100 may perform secondary auto correction, through the camera 130, by using the primary correction value based on a door opening event of the home appliance 100.

For example, the home appliance 100 may transmit an image capture request signal to the camera 130 based on the door opening event of the home appliance 100.

In an embodiment, the camera 130 may be in a power-on or power-off state before the door opening event occurs. For example, the camera 130 may perform primary auto correction and may be maintained in a power-on state. For example, when the camera 130 is in a power-off state, the home appliance 100 may control the camera 130 to be powered on by providing the power on signal to the camera 130. The camera 130 may be powered on based on the door opening event. The camera 130 may be powered on according to a user trigger.

The camera 130 may perform secondary auto correction upon receiving the image capture request signal. For example, the camera 130 may correct exposure and/or white balance in response to the surrounding light environment (lighting condition, sunlight intensity, illumination level, lighting condition of home appliance, or the like). For example, when a door opening event occurs, a lighting included in the home appliance 100 may be powered on and the surroundings may become brighter, and thus the surrounding light environment may change. The camera 130 may perform secondary auto correction in consideration of changes in the surrounding light environment.

For example, the camera 130 may perform the secondary auto correction by using the primary correction value.

The camera 130 may obtain the primary correction value corresponding to a stable state in the surrounding light environment. For example, the processor 110 may provide the primary correction value stored in the memory 120 to the camera 130, and thus set the primary correction value as an initial value (or setting value) of the secondary auto correction.

Alternatively, for example, the camera 130 may store the previously obtained primary correction value unless the primary correction value is initialized after the primary auto correction, the primary correction value may be used as the initial value (or setting value) of the secondary auto correction. For example, when the camera 130 performs primary auto correction and is then maintained in a power-on state, the camera 130 may not be initialized.

For example, the camera 130 may obtain a secondary exposure value by performing secondary AE by using a primary exposure value stabilized in response to the surrounding light environment. For example, the camera 130 may obtain secondary white balance by performing secondary AWB by using secondary white balance stabilized in response to the surrounding light environment.

In operation 1260, the home appliance 100 may obtain a captured image to which the secondary correction value is applied, through the camera 130. The camera 130 may perform secondary auto correction by using a pre-stored primary correction value as an initial value, and thus may quickly converge to an optimal correction value. The optimal correction value refers to a correction value that may ensure the accuracy of image recognition processing. The home appliance 100 may obtain object information about at least one object to which image recognition processing is applied by using the captured image.

For example, the graph in FIG. 13 shows exposure values according to AE. The x-axis of the graph represents an exposure value and may be expressed from 0 to 255. As a value of the x-axis increases, an image may become brighter. The y-axis of the graph may be the amount of pixels of the image. As the number of pixels of the image distributed in middle grey, corresponding to a center value of the x-axis, increases, it may indicate that the image has a stabilized exposure value.

The graph indicates an initial value 1310 set in the camera 130 before AE, a primary exposure value 1320 corresponding to a stable state according to the primary AE, and a secondary exposure value 1330 corresponding to a stable state according to the secondary AE. The secondary exposure value 1330 may be an optimal exposure value or a target exposure value. The exposure value of the initial value 1310 is exemplified as being close to 0, but is not limited thereto. The primary exposure value 1320 corresponds to an exposure value that is primarily stabilized in response to the surrounding light environment, and thus the distribution of middle grey may be larger than that of an image to which the initial value 1310 is applied. The secondary exposure value 1330 corresponds to an exposure value stabilized using the primary exposure value 1320, and thus the distribution of middle grey may be larger than that of an image to which the primary exposure value 1320 is applied.

The camera 130 may more quickly converge to the optimal exposure value when performing AE by using the primary exposure value 1320 than when performing AE by using the initial value 1310. The home appliance 100 may quickly obtain a captured image by storing the primary exposure value 1320 and using the primary exposure value 1320 in a secondary exposure operation.

In the graph, the secondary exposure value is exemplified as being smaller than the primary exposure value, but the secondary exposure value may be greater than the primary exposure value. The magnitudes of the primary exposure value and the secondary exposure value may vary depending on a degree of the brightness or darkness of the surrounding light environment. The color temperature set in the secondary white balance may be higher or lower than the color temperature set in the primary correction value white balance.

FIG. 14 is a flowchart for explaining an operation of obtaining a surrounding light environment change event around a home appliance, according to an embodiment of the disclosure.

FIG. 15 is an example diagram showing a surrounding light environment around a home appliance, according to an embodiment of the disclosure.

Referring to FIG. 14, in operation 1410, the server 200 may track a lighting condition around the home appliance 100. The lighting may represent a lighting device.

For example, in operation 1412, the server 200 may identify a lighting change event in which at least one lighting in an identical space to the home appliance 100 is turned on or off.

For example, in operation 1414, the server 200 may identify a first event in which all lighting conditions within an adjacent space to the home appliance 100 is turned off, or a second event in which a state where all lightings are turned off changes to a state where at least one lighting is turned on.

Referring to a layout 1500 of FIG. 15, the home appliance 100 may be located in an indoor space within a house (e.g., kitchen, living room, study, or master bedroom). The surroundings of the home appliance 100 may refer to an identical space and/or adjacent space to the home appliance 100. The identical space to the home appliance 100 may mean the same space as the home appliance 100, and the adjacent space to the home appliance 100 may mean a space closest to a space in which the home appliance 100 is located or one or more spaces separated from the home appliance 100 by a predetermined distance. For example, when the home appliance 100 is located in a kitchen, an identical space 1510 may mean the kitchen. For example, when the home appliance 100 is located in a kitchen, an adjacent space 1520 may mean a living room adjacent to the kitchen or the like.

For example, the server 200 may check states of a lighting A and a lighting B that exist in the identical space 1510 to the home appliance 100. The server 200 may identify that the lighting change event occurs when at least one of the lighting A and the lighting B is turned on or off.

For example, the server 200 may check states of lightings C, D, and E existing in the adjacent space 1520. The server 200 may identify that a first lighting change event occurs when the lightings C, D, and E are all off. The server 200 may identify that a second lighting change event occurs when one lighting, such as the lighting C, is turned on while the lighting C, D, and E are all off. The server 200 may identify that a lighting change event does not occur even if the lightings D and E are turned on while only the lighting C is turned on.

Changes in the lighting condition around the home appliance 100 may have a significant impact on the surrounding light environment around the home appliance 100. A lighting present in the adjacent space 1520 to the home appliance 100 may have less effect on changes in a light environment of the home appliance 100 than a lighting present in the identical space 1510 to the home appliance 100. Therefore, the server 200 may identify a lighting change event by considering all state changes of separate lightings in the case of a lighting present in the identical space 1510. The server 200 may identify a lighting change event by considering a case in which all lightings are turned off or one or more lightings are turned on while all lightings are turned off, in the case of a lighting existing in the adjacent space 1520.

In operation 1420, the server 200 may transfer, to the home appliance 100, information about a surrounding light environment change event around the home appliance 100.

The home appliance 100 may receive, from the server 200, information about the light environment change event according to operation 1210 of FIG. 12.

For example, the home appliance 100 may obtain the light environment change event in response to a lighting change event in which at least one lighting in an identical space to the home appliance 100 is turned on or off.

For example, the home appliance 100 may obtain the light environment change event in response to at least one of a first lighting change event in which all lighting in a space adjacent to the home appliance 100 is turned off and a second lighting change event in which a state where all lightings are turned off changes to a state where at least one lighting is turned on.

FIG. 16 is a flowchart for explaining an operation of obtaining a surrounding light environment change event around a home appliance, according to an embodiment of the disclosure.

Referring to FIG. 16, in operation 1610, the home appliance 100 may check the current time zone.

In operation 1620, the home appliance 100 may identify whether the current time zone corresponds to any one of sunrise, noon (12:00), sunset, or midnight (00:00). Changes in sunlight intensity according to a time zone may have a significant impact on the surrounding light environment around the home appliance 100.

The home appliance 100 may identify changes in sunlight intensity at a predetermined time zone (e.g., sunrise, noon (12:00), sunset, and midnight (00:00)). The home appliance 100 may obtain the surrounding light environment change event around the home appliance 100 in response to changes in sunlight intensity for each predetermined time zone according to operation 1210 of FIG. 12.

In an embodiment, the predetermined time zone is exemplified as sunrise, noon (12:00), sunset, and midnight (00:00), but is not limited thereto.

FIG. 17 is a diagram illustrating an operation in which a home appliance obtains an adjustment value by using an inference model, according to an embodiment of the disclosure.

Referring to FIG. 17, the home appliance 100 according to an embodiment may infer exposure value/white balance by using an exposure/white balance inference model 1700.

The exposure/white balance inference model 1700 may be an artificial intelligence model. The artificial intelligence model may be processed by an AI-dedicated processor designed with a hardware architecture specialized for processing the artificial intelligence model. The artificial intelligence model may be generated through training. This training may be performed on a device itself (e.g., the home appliance 100) in which the artificial intelligence according to the disclosure is performed, or through a separate server 200 and/or system. Examples of learning algorithms include supervised learning, unsupervised learning, semi-supervised learning, or reinforcement learning, but are not limited to the examples described above.

Training data 1710 of the exposure/white balance inference model 1700 according to an embodiment may be an automatically corrected exposure value and a white balance value obtained through the camera 130. The training data 1710 may vary depending on various variables obtained by the home appliance 100. For example, the exposure value according to AE and white balance according to AWB may vary depending on at least one of sunlight intensity, lighting condition in a house, and illumination sensor value in the house, which are obtained by the home appliance 100. The sunlight intensity obtained by the home appliance 100 may correspond to a time at which data is obtained. The exposure/white balance inference model 1700 may use, as the training data 1710, the exposure value and white balance that are automatically corrected differently according to at least one of the sunlight intensity, lighting condition in the house, and the illumination sensor value in the house, which are obtained by the home appliance 100. The exposure/white balance inference model 1700 may be trained while appropriately changing a weight, based on the input training data 1710.

The exposure/white balance inference model 1700 according to an embodiment may receive a surrounding light environment, for example, sunlight intensity or a lighting condition in a house (1720), and output an optimal exposure value and white balance value corresponding to the surrounding light environment (1730). For example, the home appliance 100 may input the sunlight intensity or the lighting condition in the house to the exposure/white balance inference model 1700. The exposure/white balance inference model 1700 may output an exposure/white balance value corresponding to a stable state of an auto correction operation, based on the current sunlight intensity or the lighting condition in the house. The home appliance 100 may obtain a stabilized exposure/white balance value corresponding to the current sunlight intensity or the lighting condition in the house through the exposure/white balance inference model 1700.

For example, the home appliance 100 may obtain an appropriate exposure/white balance value to be set as an initial value of the camera 130 in response to the surrounding light environment. For example, the home appliance 100 may set the exposure/white balance value obtained through the exposure/white balance inference model 1700 as an initial value 1740 of the auto correction operation of the camera 130. The camera 130 may initiate the AE or AWB operation at a value most similar to the current light environment. Accordingly, the camera 130 may quickly converge to a target value.

In an embodiment, the home appliance 100 may use, as a primary correction value, an output value of the exposure/white balance inference model 1700. For example, the home appliance 100 may obtain an exposure/white balance value stabilized in response to the surrounding light environment around the home appliance 100 by inputting to the exposure/white balance inference model 1700 information about the surrounding light environment around the home appliance 100. The home appliance 100 may perform secondary auto correction of the camera 130 by using, as the initial value, the exposure/white balance value obtained from the exposure/white balance inference model 1700. In this case, the primary auto correction operation of the camera 130 may be omitted.

Alternatively, in an embodiment, the home appliance 100 may perform primary auto correction through the camera 130 and may also perform secondary auto correction to approximate an output value of the exposure/white balance inference model 1700.

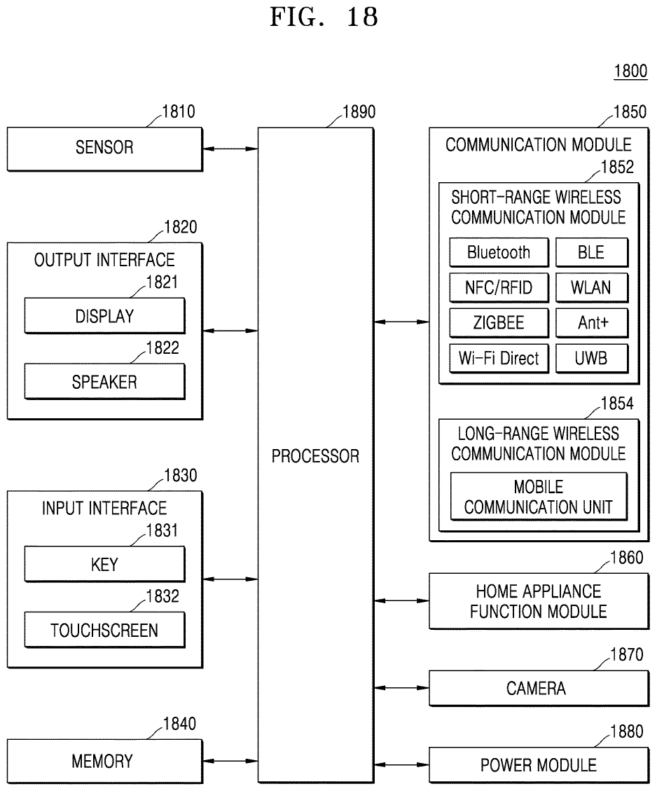

FIG. 18 is a detailed block diagram of a home appliance according to an embodiment of the disclosure.

The home appliance 100 according to an embodiment of the disclosure may correspond to a home appliance 1800. The home appliance 1800 according to an embodiment of the disclosure includes a sensor 1810, an output interface 1820, an input interface 1830, memory 1840, a communication module 1850, a home appliance function module 1860, a camera 1870, a power module 1880, and a processor 1890. The home appliance 1800 may include various combinations of the components shown in FIG. 18, and not all of the components shown in FIG. 18 are required.

The home appliance 1800 of FIG. 18 corresponds to the home appliance 100 described with reference to FIG. 4, the memory 1840 corresponds to the memory 120 described with reference to FIG. 4, the processor 1890 corresponds to the processor 110 described with reference to FIG. 4, and the camera 1870 corresponds to the camera 130 described with reference to FIG. 4.

The sensor 1810 may include various types of sensors, for example, the sensor 1810 may include various types of sensors such as an image sensor, an infrared sensor, an ultrasonic sensor, a lidar sensor, a human body detection sensor, a motion detection sensor, a proximity sensor, a handle sensor, and an illuminance sensor. A function of each sensor may be intuitively inferred by a those of skill in the art from its name, and thus a detailed description will be omitted.

The output interface 1820 may include a display 1821 and a speaker 1822. The output interface 1820 outputs various notifications, messages, information, and the like, which are generated by the processor 1890.

The input interface 1830 may include a key 1831 and a touchscreen 1832. The input interface 1830 receives user input and transfers the user input to the processor 1890.

The communication module 1850 may include at least one of a short-range wireless communication module 1852 or a long-range wireless communication module 1854 or a combination thereof. The communication module 1850 may include at least one antenna for wirelessly communicating with another device.

The short-range wireless communication module 1852 may include, but is not limited to, a Bluetooth communication module, a Bluetooth low energy (BLE) communication module, a near field communication module, a WLAN (Wi-Fi) communication module, a Zigbee communication module, an infrared (infrared data association (IrDA)) communication module, a Wi-Fi direct (WFD) communication module, an ultrawideband (UWB) communication module, an Ant+communication module, and a microwave (uWave) communication module.

The long-range wireless communication module 1854 may include a communication module that performs various types of long-range communication and may include a mobile communication unit. The mobile communication unit transmits and receives a wireless signal with at least one of a base station, an external terminal, and a server on a mobile communication network. The wireless signal may include various forms of data according to transmission and reception of a voice call signal, a video call signal, or text/multimedia messages.

The home appliance function module 1860 includes an operation module that performs an original function of the home appliance 1800. The power module 1880 is connected to a power source and supplies power to the home appliance 1800.

The processor 1890 controls the overall operation of the home appliance 1800. The processor 1890 may execute a program stored in the memory 1840 to control components of the home appliance 1800.

According to an embodiment of the disclosure, the processor 1890 may include a separate NPU that performs an operation of an artificial intelligence model. The processor 1890 may include a central processing unit (CPU), and a graphic processing unit (GPU).

According to an embodiment, the instructions, when executed by the at least one processor individually or collectively, may cause the home appliance to control the camera to perform first correction of at least one setting value based on a surrounding light environment around the home appliance, obtain at least one first corrected setting value based on the first correction, and based on a door opening event of the home appliance and based on the at least one first corrected setting value, obtain an image captured through the camera.

According to an embodiment, the user trigger comprises identifying, through a proximity sensor, a user approaching the home appliance.

According to an embodiment, the user trigger comprises identifying, through a handle sensor, a user touching a handle or a touch pressure being greater than or equal to a predetermined value.

According to an embodiment, the user trigger comprises receiving, via the communication circuitry, information indicating a human body detection event from an external device connected under a same account as the home appliance.

According to an embodiment, the instructions, when executed by the at least one processor executes the at least one instruction individually or collectively, may cause the home appliance control the home appliance not to enter a power saving mode based on identifying that a current time corresponds to a time zone when the home appliance is frequently used.

According to an embodiment, the instructions, when executed by the at least one processor individually or collectively, may cause the home appliance to obtain at least one first corrected setting value based on a result of the first correction being stable.

According to an embodiment, the instructions, when executed by the at least one processor individually or collectively, may cause the home appliance to based on the door opening event and based on the at least one first corrected setting value, control the camera to perform second correction of the at least one first corrected setting value, and obtain the image based on performing the second correction.

Pixels of the image has a greater middle grey distribution than pixels of an image captured based on the at least one first corrected setting value.

According to an embodiment, the surrounding light environment comprises a changing state of lighting condition of at least one of lighting or sunlight. According to an embodiment, the instructions, when executed by the at least one processor individually or collectively, may cause the home appliance to obtain the surrounding light environment change event around the home appliance. The at least one processor may obtain the surrounding light environment change event around the home appliance in response to an event in which at least one lighting in an identical space to the home appliance is powered on or off, and may obtain the surrounding light environment change event around the home appliance in response to at least one of a first event in which all lighting conditions within an adjacent space to the home appliance is turned off, and a second event in which a state where all lightings are turned off changes to a state where at least one lighting is turned on.

According to an embodiment, the instructions, when executed by the at least one processor individually or collectively, may cause the home appliance to obtain a surrounding light environment change event around the home appliance in response to changes in sunlight intensity for each predetermined time zone.

According to an embodiment, the instructions, when executed by the at least one processor individually or collectively, may cause the home appliance to obtain an exposure/white balance value stabilized in response to the surrounding light environment around the home appliance by inputting information about the surrounding light environment around the home appliance to an exposure/white balance inference model. The secondary auto correction may be performed based on the exposure/white balance value.

According to an embodiment, at least one processor may execute at least one instruction to control a camera to be powered on upon detecting changes in the surrounding light environment around a home appliance. The processor may store a primary correction value by performing primary auto correction, through the camera, in response to the surrounding light environment around the home appliance. The processor may obtain a captured image to which secondary auto correction of the camera is applied based on a door opening event of the home appliance.

According to an embodiment, at least one processor may execute at least one instruction to control a camera to be powered on upon detecting changes in the surrounding light environment around a home appliance. The processor may store a first primary correction value by performing primary auto correction, through the camera, in response to a first light environment around the home appliance. The processor may control the camera to be powered on based on a user trigger. The processor may store a second primary correction value by performing primary auto correction, through the camera, in response to a second light environment around the home appliance. The processor may obtain a captured image to which secondary auto correction of the camera is applied using at least one of the first primary correction value and the second secondary correction value based on a door opening event of the home appliance.

A control method of a home appliance including a camera according to an embodiment includes controlling the camera to be powered on based on a user trigger, storing a primary correction value by performing primary auto correction, through the camera, in response to a surrounding light environment around the home appliance, and obtaining a captured image to which secondary auto correction of the camera is applied based on a door opening event of the home appliance. The secondary auto correction may be performed based on the primary correction value.

According to an embodiment of the disclosure, the camera may be powered on based on a user trigger before a door opening event of a home appliance occurs. The home appliance may quickly obtain a captured image by using the camera that is powered on in advance in response to the door opening event.

According to an embodiment of the disclosure, auto correction may be performed in advance based on the surrounding light environment around the home appliance before the door opening event of the home appliance occurs, and the correction value may be stored. The home appliance may quickly converge to a target value by performing auto correction by using a pre-stored correction value based on the door opening event.

A device-readable storage medium may be provided in the form of a non-transitory storage medium. The term ‘non-transitory storage medium’ simply means a tangible device that does not contain a signal (e.g. electromagnetic wave), and the term does not distinguish between cases in which data is stored semi-permanently or temporarily in a storage medium. For example, the ‘non-transitory storage medium’ may include a buffer in which data is temporarily stored.

According to an embodiment, methods according to various embodiment disclosed in the disclosure may be provided as provided in a computer program product. The computer program product may be traded between a seller and a buyer as commodities. The computer program product may be distributed in the form of a machine-readable storage medium (e.g., compact disc read only memory (CD-ROM)), or may be distributed online (e.g., by download or upload) via an application store or directly between two user devices (e.g., smartphones). In the case of online distribution, at least some of computer program products (e.g., a downloadable application) may be temporarily stored or temporarily generated in a device-readable storage medium, such as memory of a server of a manufacturer, a server of an application store, or an intermediary server.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A home appliance comprising:
a camera;
memory, comprising one or more storage media, storing instructions; and
at least one processor communicatively coupled to the camera and the memory,
wherein the instructions, when executed by the at least one processor individually or collectively, cause the home appliance to:
based on a user trigger, control the camera to be powered on,
control the camera to perform first correction of at least one setting value based on a surrounding light environment around the home appliance,
obtain at least one first corrected setting value based on the first correction, and
based on a door opening event of the home appliance and based on the at least one first corrected setting value, obtain an image captured through the camera.

2. The home appliance of claim 1, further comprising:
a proximity sensor,
wherein the user trigger comprises identifying, through the proximity sensor, a user approaching the home appliance.

3. The home appliance of claim 1, further comprising:
a handle sensor located on a door of the home appliance,
wherein the user trigger comprises identifying, through the handle sensor, a user touching a handle or a touch pressure being greater than or equal to a predetermined value.

4. The home appliance of claim 1, further comprising:
communication circuitry,
wherein the user trigger comprises
receiving, via the communication circuitry, information indicating a human body detection event from an external device connected under a same account as the home appliance.

5. The home appliance of claim 1,
wherein the instructions, when executed by the at least one processor executes the at least one instruction individually or collectively, further cause the home appliance control the home appliance not to enter a power saving mode
based on identifying that a current time corresponds to a time zone when the home appliance is frequently used.

6. The home appliance of claim 1, wherein the instructions, when executed by the at least one processor individually or collectively, further cause the home appliance to:
obtain at least one first corrected setting value based on a result of the first correction being stable.

7. The home appliance of claim 1,
wherein the instructions, when executed by the at least one processor individually or collectively, cause the home appliance to:
based on the door opening event and based on the at least one first corrected setting value, control the camera to perform second correction of the at least one first corrected setting value, and
obtain the image based on performing the second correction.

8. The home appliance of claim 7,
wherein pixels of the image has a greater middle grey distribution than pixels of an image captured based on the at least one first corrected setting value.

9. The home appliance of claim 1,
wherein the surrounding light environment comprises a changing state of lighting condition of at least one of lighting or sunlight.

10. The home appliance of claim 1,
wherein the instructions, when executed by the at least one processor individually or collectively, further cause the home appliance to obtain an exposure/white balance value stabilized corresponding to the surrounding light environment around the home appliance by inputting to an exposure/white balance inference model information about the surrounding light environment around the home appliance, and
wherein the image comprises an image obtained based on the exposure/white balance value.

11. A method performed by a home appliance including a camera, the method comprising:
based on a user trigger, controlling the camera to be powered on;
controlling the camera to perform first correction of at least one setting value based on a surrounding light environment around the home appliance;
obtain at least one first corrected setting value based on the first correction; and
based on a door opening event of the home appliance and based on the at least one first corrected setting value, obtaining an image captured through the camera.

12. The method of claim 11, wherein the user trigger comprises identifying a user approaching the home appliance, through a proximity sensor.

13. The method of claim 11, wherein the user trigger comprises identifying, a the handle sensor, a user touching a handle or a touch pressure being greater than or equal to a predetermined value.

14. The method of claim 11, wherein the user trigger comprises receiving, via communication circuitry, information indicating a human body detection event from an external device connected under a same account as the home appliance.

15. The method of claim 11, further comprising:
controlling the home appliance not to enter a power saving mode:
based on identifying that a current time corresponds to a time zone when the home appliance is frequently used.

16. The method of claim 11, further comprising:
obtaining at least one first corrected setting value based on a result of the first correction being stable.

17. The method of claim 11, further comprising:
based on the door opening event and based on the at least one first corrected setting value, controlling the camera to perform second correction of the at least one first corrected setting value, and
obtaining the image based on performing the second correction,
wherein pixels of the image has a greater middle grey distribution than pixels of an image captured based on the at least one first corrected setting value.

18. The method of claim 11, wherein the surrounding light environment comprises a changing state of lighting condition of at least one of lighting or sunlight.

19. One or more non-transitory computer-readable storage media storing one or more computer programs including computer-executable instructions that, when executed by one or more processors of a home appliance device individually or collectively, cause the home appliance device to perform operations, the operations comprising:
based on a user trigger, controlling the camera to be powered on;
controlling the camera to perform first correction of at least one setting value based on a surrounding light environment around the home appliance;
obtain at least one first corrected setting value based on the first correction; and
based on a door opening event of the home appliance and based on the at least one first corrected setting value, obtaining an image captured through the camera.

20. The one or more non-transitory computer-readable storage media of claim 19, wherein the user trigger comprises identifying a user approaching the home appliance, through a proximity sensor.
